(19) United States
(12) Patent Application Publication
(10) Pub. No.: US 2008/0059298 A1
(43) Pub. Date: Mar. 6, 2008

(54) DYNAMIC KEYWORD AUCTIONING SYSTEM, METHOD AND COMPUTER PROGRAM PRODUCT

(75) Inventors: Jason A. Waag, Arlington, VA (US); Michal C. Dabrowski, Beltsville, MD (US); Todd Watts, Leesburg, VA (US); Kari Rippetoe, Arlington, VA (US); Lisa Koenigsberg, Yonkers, NY (US); Asad Haroon, Vienna, VA (US)

Correspondence Address: VENABLE LLP, P.O. BOX 34385, WASHINGTON, DC, 20043-9998, US

(73) Assignee: Liquidity Services Inc., Washington, DC (US)

(21) Appl. No.: 11/675,050

(22) Filed: Feb. 14, 2007

Related U.S. Application Data
(60) Provisional application No. 60/773,345, filed on Feb. 15, 2006.

(51) Int. Cl. G06Q 30/00

(52) U.S. Cl. 705/14

(57) ABSTRACT

A system, method and computer program product for dynamic auctioning of keyword search terms, in an exemplary embodiment, may include: a) receiving a search query; b) parsing the search query into one or more keywords; c) retrieving search listings, including at least one auto-bid search listing, for each keyword, where the search listings are associated with a bid amount; d) calculating a bid amount for each of the auto-bid search listings based on at least a first budget balance, where the first budget balance is calculated based on a first budget that is associated with the auto-bid search listing; and e) sorting at least a portion of the search listings based on said bid amount.

### CROSS-REFERENCE TO RELATED APPLICATIONS

This application is related to, claims the benefit of under 35 U.S.C. Section 119(e), and is a nonprovisional of U.S. Patent Application Ser. No. 60/773,345, entitled, “Dynamic Keyword Auctioning System and Method”, to WAAG et al., Attorney Docket No. 70878-232780 (formerly 80395-0008 PROV), filed Feb. 15, 2006, of common assignee to the present invention, the contents of which are incorporated herein by reference in their entireties.

### BACKGROUND OF THE INVENTION

1. Field of the Invention

The invention relates to on-line advertising placements based upon keyword searching, and more particularly to a system and method for dynamically ordering advertising placements based upon on-line bids.

2. Description of the Related Art

The world wide web (WWW) now encompasses a wide variety of webpages, including business and commercial webpages, governmental webpages and personal webpages. In view of the large number and variety of webpages, internet search engines have become an increasingly important tool for navigating the WWW. Internet search engines typically search for webpages based upon keywords that are provided by the party requesting the search.

A number of search engines have sought to generate revenue by allowing websites to pay for keywords so that those websites appear in the search results.

One conventional payment model is referred to as the “Paid Inclusion” model. In the Paid inclusion model, the search engine company charges websites fees for including them in the search index of their search engine. Paid inclusion products are provided by many search engine companies, a notable exception being Google. The paid inclusion fee structure is both a filter against superfluous submissions and a revenue generator for search companies. Typically, the fee may cover an annual subscription for one webpage, which may automatically be catalogued on a regular basis. A per-click fee may also apply. For example, a fee may be charged per click-through. Each search engine is different. Some sites allow only paid inclusion. More frequently, many search engines, like Yahoo!, mix paid inclusion (per-page and per-click fee) with results from web crawling. Other search engines, like Google and Ask.com, for example, do not let webmasters pay to be in their search engine listing (advertisements may be shown separately and labeled as such). Some detractors of paid inclusion contend that it causes searches to return results based more on the economic standing of the interests of a web site, and less on the relevancy of that site to end-users. Often the line between pay-per-click advertising and paid inclusion is debatable. Some have lobbied for any paid listings to be labeled as an advertisement, while defenders insist they are not actually ads since the webmasters do not control the content of the listing, its ranking, or even whether it is shown to any users. Another advantage of paid inclusion is that it allows site owners to specify particular schedules for crawling pages. In the general case, one has no control as to when their page may be crawled or added to a search engine index. Paid inclusion proves to be particularly useful for cases where pages are dynamically generated and frequently modified.

Paid inclusion is a search engine marketing method in itself, but also may be a tool of search engine optimization, since experts and firms can test out different approaches to improving ranking, and see the results often within a couple of days, instead of waiting weeks or months. Knowledge gained this way can be used to optimize other web pages, without paying the search engine company.

Another conventional payment model is the “Pay-for-Performance” model. In the pay for performance model, keywords may be auctioned off by the search engine company to websites and the included websites then pay the search engine for every click-through that is received by the website. One pay-for-performance model is pay-per-click (PPC). Pay-per-click is an advertising technique, which may be used on, e.g., websites, advertising networks, and search engines. Advertisers bid on keywords that they believe that their target market (i.e., users that the advertiser think would be interested in their offering) would type in a search field query when the users are looking for advertisers' type of product or service. For example, if an advertiser sells widgets, the advertise might bid on the keyword “widgets,” hoping a user would type that keyword in a search query, see their advertisement (ad), click on it and buy the widget. These ads are referred to as “sponsored links” or “sponsored ads” and appear next to and sometimes above the natural or organic results on the page. The advertiser pays only when the user clicks on the ad, referred to as a “click-through.” Example service offerings include, e.g., but not limited to, GoWholesale.com available from Liquidity Services, Inc. of Washington, D.C. USA, Google AdWords available from Google Inc. of Mountain View, Calif., USA, Yahoo! Search Marketing, which was formerly Overture, available from Yahoo! Inc. of Sunnyvale, Calif. USA, and Microsoft Network (MSN) adCenter, available from Microsoft Corporation of Redmond, Wash. USA. Depending on the search engine, prices per click (PPC) may start at a minimum (such as, e.g., but not limited to, US$0.01, US$0.15, US$0.20, US$0.50, etc.). Very popular search terms can cost much more on popular engines. Abuse of the pay per click model can result in click fraud.

While the pay for performance model does offer the ability to auction keywords, pay for performance is conventionally a fairly static model that does not offer advertisers the ability to quickly change their placement position in view of varying click-through traffic and changing advertising budgets. This is particularly of concern to advertisers who want their websites prominently displayed because premium placements can attract significantly higher consumer interest. Thus, it would be desirable to have a payment model that is more responsive to Internet traffic and changes in advertiser budgets.

### SUMMARY OF THE INVENTION

Various exemplary embodiments of the present invention may include a system, method and/or computer program product for dynamic auctioning of keyword search terms by search engines.

An exemplary embodiment may include a method, which may include: a) receiving a search query; b) parsing the search query into one or more keywords; c) retrieving search listings, including at least one auto-bid search listing, for each keyword, where the search listings may be associated with a bid amount; d) calculating a bid amount for each of the auto-bid search listings based on at least a first budget balance, where the first budget balance may be calculated based on a first budget that may be associated with the auto-bid search listing; and e) sorting at least a portion of the search listings based on the bid amount.

In an exemplary embodiment, step (d) of calculating a bid amount may further include: setting the bid amount of the auto-bid search listing associated with the lowest first budget balance to a minimum auto-bid amount; and incrementing the bid amount of the subsequent auto-bid search listings, in the order of the first budget balance, by a bid increment amount. In a further exemplary embodiment, where calculated bid amount for any auto-bid search listings may exceed a maximum auto-bid amount, step (d) may further include: setting the bid amount of the auto-bid search listing associated with the highest first budget balance to the maximum auto-bid amount; and decrementing the bid amount of subsequent auto-bid search listings, in the decreasing order of the first budget balance, by a bid decrement amount until the bid amount reaches the minimum auto-bid amount, then setting the auto-bid amount of the remaining auto-bid search listings to the minimum auto-bid amount.

In an exemplary embodiment, the search listings may include at least one manual bid search listing. In this exemplary embodiment, the step (d) of calculating a bid amount may include: setting the bid amount of the auto-bid search listing that may be associated with the lowest first budget balance to the lowest bid amount that may be greater than or equal to a minimum auto-bid amount and not equal to the bid amount of any of the manual bit search listings; and for each of the remaining auto-bid search listings, setting the bid amount of the auto-bid search listing to the bid amount of the auto-bit listing that was just set, incremented by a bid increment amount; determining whether the bid amount of the auto-bid search listing may be equal to the bid amount of any of the manual bid search listings; and if so, continuously incrementing the bid amount of the auto-bid search listing by the bid increment amount until reaching an amount that is not equal to the bid amount of any of the at least one manual bid search listings.

In a further exemplary embodiment, where the bid amount associated with any auto-bid search listings exceed a maximum auto-bid amount, the step (d) of calculating a bid amount may further include: setting the bid amount of the auto-bid search listing associated with the highest first budget balance to the maximum auto-bid amount; and for each of the remaining auto-bid search listings, if the bid amount of the auto-bid search listing may be equal to or greater than the bid amount of the auto-bid search listing that was just set prior to this auto-bid search listing, then setting the bid amount of this auto-bid search listing to the bid amount of that prior auto-bid search listing decremented by a bid decrement amount; and if the bid amount of the auto-bid search listing reaches the minimum auto-bid amount, then setting the bid amount of each of the remaining auto-bid search listings to the minimum auto-bid amount.

In an exemplary embodiment, step (c) of retrieving search listings may include sorting the auto-bid search listings in the order of their first budget balance. In one exemplary embodiment, the method may further include f) displaying the search listings in the sorted order.

In an exemplary embodiment, the first budget may be allocated for a first time period. In a further exemplary embodiment, the first budget balance may be calculated as the difference between the first budget and the amount of the first budget that may have been so far expended in the first time period. In a yet further exemplary embodiment, the method may further include determining whether the first budget balance may be less than a first budget minimum; and if so, may set all search listings associated with the first budget offline. In another further exemplary embodiment, the method may further include determining whether the first budget balance may be less than a first budget minimum and whether an auto-replenishment option may be available for the first budget; and if so, auto-replenishing the first budget; and otherwise, may set all search listings associated with the first budget offline.

In a further exemplary embodiment, the auto-replenishing of the first budget may include requesting a transfer of money from a financial account to the first budget and replenishing the first budget if the transfer is successful; and otherwise may include setting all search listings associated with the first budget offline. In an exemplary embodiment, the financial account may include, but is not limited to, a user account, a bank account, a credit account, and/or a debit account, etc.

In an exemplary embodiment, the method may further include determining whether the first budget balance may be greater than or equal to a first budget minimum and any auto-bid search listings associated with the first budget may be offline, and if so, may include setting, e.g., but not limited to, all search listings associated with the first budget online.

In an exemplary embodiment, the method may include determining whether a user account may be less than an account minimum; and if so, may set, e.g., but not limited to, all, search listings for the user account offline. In another exemplary embodiment, the method may include determining whether a user account may be less than an account minimum and whether an auto-replenishment option may be available for that user account; and if so, may include auto-replenishing the user account; and may otherwise, set all search listings associated with the user account offline.

In an exemplary embodiment, the auto-replenishing of the user account may include: requesting a transfer of money from a financial account to the user account and replenishing the user account if the transfer is successful; and otherwise may include setting all search listings associated with the user account offline. In an exemplary embodiment, the financial account may include, but is not limited to, a bank account, a credit account, and/or a debit account, etc.

In an exemplary embodiment, the first budget may be calculated based on a second budget, where the second budget may be allocated for a second time period. In an exemplary embodiment, the method may further include calculating a second budget balance as the difference between the second budget and the amount of the second budget that is so far expended in the second time period. In a further exemplary embodiment, the calculation of a second budget balance may be performed at least once within every first time period.

In an exemplary embodiment, the amount of first budget so far expended may correspond to an amount expended from a user account to pay for displaying the listings, click-throughs, call-throughs, and/or sale-throughs, etc., for at least one search listing associated with the account, where calculating the first budget balance may take place at set predetermined time intervals, and the step of sorting the least a portion of the plurality of search listings also may take place at set predetermined time intervals.

In an exemplary embodiment, the method may further include: determining whether the second budget balance may be greater than or equal to a second budget minimum and any auto-bid search listings associated with the second budget may be offline; and if so, may include setting all search listings associated with the second budget online.

In an exemplary embodiment, the second time period may be a multiple of the first time period. In an exemplary embodiment, the method may further include calculating the first budget as a second budget balance divided by the number of first time periods remaining in the second time period, where the second budget balance may be the difference between the second budget and the amount of the second budget that may have been so far expended in the second time period.

In some exemplary embodiments, the first time period may be a 24-hour day and the second time period may be a month. Also, in an exemplary embodiment, the first time budget may be a daily budget and the second budget may be a monthly budget. Further, in an exemplary embodiment, the first budget balance may be calculated every 15 minutes. In exemplary embodiments, the first or second budget balance may be calculated on, e.g., but not limited to a periodic and/or an aperiodic basis.

In an exemplary embodiment, the second time period may begin on the day of the month corresponding to the day when a user associated with the second time period registered for an account and may extend one month from that day. In an exemplary embodiment, the month, may be set at 30 days, in an exemplary embodiment.

In an exemplary embodiment, the search listings may include a manual bid search listing, an auto bid search listing, a power bid search listing, and/or a featured bid search listing, etc.

In an exemplary embodiment, the search listings may include at least one power bid search listing, the method may further include: taking an average of the bid amounts associated with a group of search listings having the highest bid amounts; and calculating a bid amount for the power bid search listing based on that average. In an exemplary embodiment, the bid amount for the power bid search listing may be calculated by raising the average by either a predetermined percentage and/or a predetermined amount. In exemplary embodiments, the predetermined percentage may be, e.g., but not limited to, five percent, ten percent, fifteen percent, twenty percent, etc. In exemplary embodiments, the group of search listings may include one, two, three, or more search listings having high bid amounts. In an exemplary embodiment, there may be a minimum power bid amount.

In an exemplary embodiment, where the search listings include at least one featured bid search listing, the method may include: f) calculating a bid amount for one of the featured bid search listings (e.g. selected at random from the group of featured bid search listings) by incrementing the highest bid amount associated with the plurality of search listings by a predetermined feature bid increment amount; and g) for all remaining featured bid search listings may include: selecting a featured bid search listing (e.g. at random) from the featured bid search listing; and calculating a bid amount for the featured bid search listing by incrementing the bid amount of the featured bid search listing that was set just prior to this featured bid search listing by a predetermined feature bid increment amount.

In an exemplary embodiment, the first budget may be an advertising budget associated with an advertiser. In a further exemplary embodiment, the method may further include: receiving the advertising budget from the advertiser; and receiving a plurality of the keywords from the advertiser. In a further exemplary embodiment, the method may further include receiving a selection of a payment plan from the advertiser. In an exemplary embodiment, the payment plan may be a term budget plan, a constant traffic plan, and/or a pay-per-click plan, etc. In an exemplary embodiment, the term budget plan may e.g., but not limited to, be a daily, weekly, monthly budget plan, etc.

In an exemplary embodiment, a bidding option may be received for each keyword individually. In another exemplary embodiment, a bidding option may be associated all keywords collectively. In an exemplary embodiment, if the payment plan may be the constant traffic plan, the bidding option may be a manual bid, a featured bid, and/or a power bid. However, in an exemplary embodiment, if the payment plan may be the term budget plan, the bidding option may include a manual bid, a featured bid, an auto bid, and/or a power bid, etc.

In an exemplary embodiment, the method may further include g) receiving a click-through for at least one the search listings; and h) deducting the bid amount of the search listing associated with that click-through from the first budget balance of that search listing.

In an exemplary embodiment, the bid amount may be associated with, e.g. but not limited to, a cost-per-click, a cost-per-listing, a cost-per-call, and/or cost-per-sale. In an exemplary embodiment, a search listing may be e.g., but not limited to, a website link, a sale listing, an advertisement, an advertising banner, and/or a sale item.

Another exemplary embodiment of the invention may include, e.g., but not limited to, a method, a system, and/or a computer program product, which may include, e.g., but not limited to, a) receiving a search query; b) parsing the search query into at least one keyword; c) retrieving a plurality of auto-bid search listings associated with the keyword, where each auto-bid search listings may be associated with a first budget; d) calculating a first budget balance for each of the auto-bid search listings, where the first budget balance may be calculated based on the first budget; and e) sorting the plurality of the auto-bid search listings in the order of the first budget balances. In an exemplary embodiment, the method may further include f) displaying the plurality of auto-bid search listings in the sorted order.

In an exemplary embodiment, the each auto-bid search listing may have a bid amount associated with it. In one exemplary embodiment, the method may include setting the bid amount of the auto-bid search listing that has the lowest first budget balance to a minimum auto-bid amount; and setting the bid amount of each of the next auto-bid search listings to the bid amount of its previous auto-bid search listing incremented by a bid increment amount as traversing through the plurality of auto-bid search listings in the sorted order. In a further exemplary embodiment, the method may further include: determining whether the bid amount of the auto-bid search listing that has the highest first budget balance exceeds a maximum auto-bid amount; and if so, setting the bid amount of the auto-bid search listing associated with the highest first budget balance to a maximum auto-bid amount; and setting the bid amount of each of the next auto-bid search listings to the bid amount of its previous auto-bid search listing decremented by a bid decrement amount as traversing through the plurality of auto-bid search listings in the reverse of the sorted order until the bid amount of the auto-bid search listing reaches the minimum auto-bid amount, then setting the bid amount of the remaining auto-bid search listings to the minimum auto-bid amount. In an exemplary embodiment, the bid increment amount may be equal to the bid decrement amount.

In another exemplary embodiment, the method may include determining whether the number of auto-bid search listings in the plurality of auto-bid search listings may be greater than the difference between a maximum auto-bid amount and a minimum auto-bid amount divided by a bid increment amount; and if so, setting the bid amount of the auto-bid search listing that has the lowest first budget balance to the minimum auto-bid amount; setting the CPC of each of the next auto-bid search listings to the bid amount of its previous auto-bid search listing incremented by a bid increment amount as traversing through the plurality of auto-bid search listings in the sorted order; otherwise, setting the bid amount of the auto-bid search listing that has the highest first budget balance to the maximum auto-bid amount; and, setting the bid amount of each of the next auto-bid search listings to the bid amount of its previous auto-bid search listing decremented by a bid decrement amount as traversing through the auto-bid search listings in the reverse of the sorted order until the bid amount of the auto-bid search listing reaches the minimum auto-bid amount, then setting the bid amount of the remaining auto-bid search listings to the minimum auto-bid amount. In an exemplary embodiment, the bid increment amount may be equal to the bid decrement amount.

An exemplary embodiment of the invention includes a method of calculating a power bid, where the method may include: taking an average of a plurality of high bids; and setting the power bid to the average raised by at least one of a predetermined percentage and/or a predetermined amount. In an exemplary embodiment, there may be one, two, three, or more high bids used for taking the average. In an exemplary embodiment, the predetermined percentage may be, e.g., five percent, ten percent, fifteen percent, etc. In an exemplary embodiment, the average of the high bids may equal X, where X may be equal to ((a Highest Bid (HB)+a Second Highest Bid (SHB)+a Third Highest Bid (THB))/3, and the power bid may be equal to the sum of X and the product of 0.15 (for 15%, etc.) and X.

In an exemplary embodiment, the method may further include determining whether the power bid may be below a minimum power bid amount; and if so, setting the power bid to the minimum power bid amount. In an exemplary embodiment, the high bids may correspond to the bid amounts of a plurality of search listings having the highest bid amounts.

An exemplary embodiment of the invention may include, e.g., but not limited to, a system, where the system may include, e.g., but not limited to: means for receiving a search query; means for parsing the search query into one or more keywords; means for retrieving search listings, including at least one auto-bid search listing, for each keyword, where the search listings may be associated with a bid amount; means for calculating a bid amount for each of the auto-bid search listings based on at least a first budget balance, where the first budget balance may be calculated based on a first budget that may be associated with the auto-bid search listing; and means for sorting at least a portion of the search listings based on the bid amount.

An exemplary embodiment of the invention may include a computer readable medium embodying program logic, which, when executed, may perform a method, which may include, in an exemplary, but non-limiting embodiment: a) receiving a search query; b) parsing the search query into one or more keywords; c) retrieving search listings, including at least one auto-bid search listing, for each keyword, where the search listings may be associated with a bid amount; d) calculating a bid amount for each of the auto-bid search listings based on at least a first budget balance, where the first budget balance may be calculated based on a first budget that may be associated with the auto-bid search listing; and e) sorting at least a portion of the search listings based on the bid amount.

### BRIEF DESCRIPTION OF THE DRAWINGS

Various exemplary features and advantages of the invention may be apparent from the following, more particular description of exemplary embodiments of the present invention, as illustrated in the accompanying drawings wherein like reference numbers generally indicate identical, functionally similar, and/or structurally similar elements. The left most digits in the corresponding reference number indicate the drawing in which an element first appears:

FIG. 1 depicts a block diagram of an exemplary system in accordance with an exemplary embodiment of the invention;

FIG. 2 depicts an exemplary embodiment of an exemplary flow diagram in accordance with an exemplary embodiment of the invention;

FIGS. 3A and 3B set forth an exemplary embodiment of an exemplary flow diagram of calculating the cost-per-click (CPC) amounts for the auto-bid search listings in accordance with an exemplary embodiment of the invention;

FIGS. 4A through 4E set forth an example illustrating the sorting of auto-bid search listings and manual bid search listings in accordance with an exemplary embodiment of the invention;

FIG. 5 depicts an exemplary embodiment of an exemplary flow diagram illustrating the processing of power bid search listings in accordance with an exemplary embodiment of the invention;

FIG. 6 depicts an exemplary embodiment of an exemplary flow diagram illustrating the processing of featured bid search listings in accordance with an exemplary embodiment of the invention;

FIGS. 7A and 7B depict an exemplary embodiment of exemplary flow diagrams illustrating the processing of bid deductions in accordance with an exemplary embodiment of the invention;

FIG. 8 depicts an exemplary embodiment of an exemplary flow diagram illustrating the processing of an advertiser's registration or account update in accordance with an exemplary embodiment of the invention;

FIG. 9 depicts an exemplary embodiment of an exemplary flow diagram illustrating the processing of the second budget (e.g. monthly budget) to calculate the first budget (e.g. daily budget) in accordance with an exemplary embodiment of the invention;

FIG. 10 depicts an exemplary embodiment of an exemplary flow diagram illustrating the processing of the first budget (e.g. daily budget) in accordance with an exemplary embodiment of the invention; and

FIG. 11 depicts an exemplary computer system that may be used in implementing an exemplary embodiment of the present invention.

### DETAILED DESCRIPTION OF VARIOUS EXEMPLARY EMBODIMENTS

Various exemplary embodiments including a preferred embodiment of the present invention are discussed in detail below. While specific exemplary embodiments are discussed, it should be understood that this is done for illustration purposes only. A person skilled in the relevant art will recognize that other components and configurations may be used without parting from the spirit and scope of the invention.

### EXEMPLARY GLOSSARY OF TERMS WITH EXEMPLARY BUT NON-LIMITING DEFINITIONS

Auto Bid—According to an exemplary embodiment, an autobid may provide an advertiser: (a) a bid amounts which may be determined by an automated process which may run, e.g., but not limited to, every 15 minutes, hourly, daily, etc.; (b) a keyword-bidding feature that may automatically bid on advertiser keywords so that the advertiser does not have to constantly monitor the keywords herself or himself. According to one exemplary embodiment, a monthly budget may be a required payment plan when using an auto bid, because the system, according to an exemplary embodiment, may adjust an advertiser's position to get the advertiser the most traffic possible based on the monthly budget the advertiser sets.

Broad Match—According to an exemplary embodiment, an advertiser may opt to broad match keywords, which may display listings if any variations on the keyword may be searched (i.e., if an advertiser subscribes to a broad match of the keyword “jewelry”, then the advertiser's listing may also appear for search queries containing the word “jewelry,” such as, e.g., but not limited to, “gold jewelry” and/or “silver jewelry”).

Constant Traffic—According to an exemplary embodiment, the constant traffic plan may be used, if an advertiser wants the search engine provider to bill the advertiser's credit card automatically whenever the advertiser's account goes below, e.g., but not limited to, $25. According to an exemplary embodiment, the advertiser can select the amount that the advertiser may want to be charged when the advertiser's account is low, and the advertiser may then receive an email whenever the advertiser's credit, debit, and/or charge card, etc., may be automatically charged. According to one exemplary embodiment, the advertiser may also receive a bonus such as, e.g., but not limited to, a special 5% account bonus.

Cost-per-click (CPC)—According to an exemplary embodiment, CPC may stand for “Cost Per Click,” and may be used in online advertising. According to an exemplary embodiment, CPC may define how much revenue a publisher may receive, e.g., but not limited to, each time a user clicks an advertisement link on the publisher's website. For example, according to one exemplary embodiment, a publisher may place text or image-based ads on the publisher's website. According to an exemplary embodiment, when a visitor or user clicks one of the publisher's advertisements, he or she may be directed to the advertiser's website. Each click may be recorded by the advertiser's tracking system, and the publisher may be paid a certain amount based on the CPC, according to an exemplary embodiment.

First Budget (e.g., Daily Budget)—According to an exemplary embodiment, an amount of a first budget (e.g., daily budget, etc.) may be the funds available to an advertiser on any budget plan (i.e., not Constant Traffic and/or Pay as you Go, according to an exemplary embodiment). Once the daily or first budget funds may be depleted, the advertiser may be taken offline for the day. The first budget may be a calculated amount based on a second budget. For example, a daily budget may be calculated by taking a monthly budget remaining for the remainder of a month, divided by the number of days remaining of the month. In an exemplary embodiment, the month may be, e.g., but not limited to, a calendar month, and/or may be a time period such as, e.g., but not limited to, 30 days, from, e.g., but not limited to, an opening of a user account, or other event, etc.

First and/or Daily Budget Balance—According to an exemplary embodiment, a first and/or daily budget balance may include, e.g., but not limited to, a remaining daily, and or other budget balance fund available for bidding. According to an exemplary embodiment, once the daily and/or other budget balance may be depleted, the advertiser may be taken offline for a day, or the budget may be replenished if auto-replenishment is authorized.

Featured Bid—According to an exemplary embodiment, all keywords may have up to, e.g., but not limited to, one, two, three and/or more, etc., featured bid positions available. According to an exemplary embodiment, making one or more of an advertiser's keywords a featured bid, may set the bid for those one or more keyword listings so that the bids may be automatically a predetermined amount, e.g., but not limited to, 1 cent ($0.01), 2 cents ($0.02), or 3 cents ($0.03), etc., higher than the current highest bidder, depending on which of the three featured positions that an advertiser may be in. According to an exemplary embodiment, the cost per visitor for a featured listing may go up as bids below an advertiser's bid go up.

Manual Bid—According to an exemplary embodiment, a manual bid may be a bidding method that may allow the advertiser to indicate the bid amounts on a keyword by keyword basis.

Second Budget (e.g., but not limited to, a Monthly Budget)—According to an exemplary embodiment, a second budget, such as, e.g., but not limited to, a monthly budget plan may allow an advertiser to limit the amount of money that the advertiser may spend on an advertising campaign for an associated time period of the second budget, such as a monthly budget for each month. According to an exemplary embodiment, for a monthly budget, the advertiser may select a monthly maximum budget that the advertiser may want to spend, which may then be divided into a daily budget, i.e., a “daily spend”, first budget amounts by dividing the second budget by the number of first time periods remaining in the second time period (e.g., divide the remaining monthly budget by the number of days left in the month). According to an exemplary embodiment, an advertiser's account may be automatically replenished with a corresponding deposit amount every time that the account account may fall below a threshold such as, e.g., but not limited to, $25, etc.

Monthly Budget Balance—According to an exemplary embodiment, a monthly budget balance, may be an amount of a remaining monthly budget available for spending after subtracting any click-throughs. Once a monthly budget balance has been depleted, according to an exemplary embodiment, the advertiser may be taken offline for the month, and/or if auto-replenishment has been authorized, may be replenished, automatically.

Pay as you Go—According to an exemplary embodiment, an exemplary pay as you go plan may be chosen by an advertiser, if the advertiser wants to wait until the advertiser's account reaches a low balance and then the account may prompt the advertiser to manually enter a credit card to fund the advertiser's account, according to an exemplary embodiment. According to an exemplary embodiment, the search engine service provider may send the advertiser an alert such as, e.g., but not limited to, a message, an instant message, a short message system (SMS) message, a multimedia message system (MMS) message, and/or an electronic mail (email) notification, when the advertiser's account may be low on funds, and/or out of funds, etc.

Power Bid—According to an exemplary embodiment, an exemplary power bid may be used when an advertiser may wish to be close to the top, by providing an optimal amount for an advertiser's bid, for the advertiser's listing (e.g., link, content, etc.) to be placed within the top few positions of search results. According to an exemplary embodiment, the power bid may allow placing an ad near the top across a network and/or maximizing an amount of traffic that the advertiser's web site may receive, related to the listings.

Exemplary System Environment

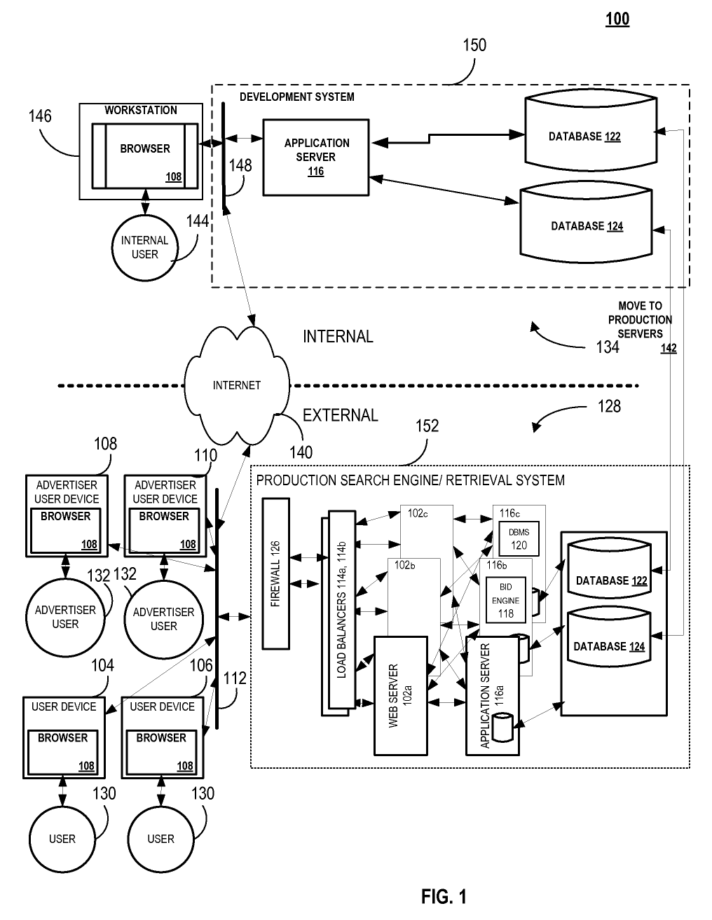

FIG. 1 depicts an exemplary embodiment of a system block diagram 100, which may include, e.g., but is not limited to, an exemplary internal development system block diagram 134 and an exemplary external production system block diagram 128, according to an exemplary embodiment of the present invention.

The internal development system block diagram 134 may include, according to an exemplary embodiment, a browser 108 executing on a user device 146, enabling interactive access for an internal user 144 to an exemplary development system 150. The workstation 146, according to an exemplary embodiment, may be coupled via a network 148 to an application server 116 such as, e.g., but not limited to, a database management system (DBMS). The database management system application server 116, according to an exemplary embodiment, may manage access to one or more databases 122, 124. In an exemplary embodiment, the database management system application server 116 may manage an order database 122, and a report database 124. It will be apparent to those skilled in the art that databases 122, 124 could be part of a single larger database 122, 124, or each could be broken into a plurality of separate sub-databases. The database development and processing performed by internal user 144, according to an exemplary embodiment, may include, e.g., but is not limited to, defining, managing, running reports, etc., on databases 122, 124.

External production system block diagram 128 may include, in an exemplary embodiment, a browser 108 which may execute on a user device 104, 106, and which may enable interactive access for users 130 to a production search engine retrieval system 152. Similarly, the browser 108, according to an exemplary embodiment, may be executing on an advertiser user device 108, 110, and may enable interactive access for advertising users 132 to the production search engine retrieval system 152. In the exemplary embodiment of the invention, the user devices 104 and 106, as well as advertiser user devices 108 and 110, may be coupled via a network 112 and/or the global Internet 140, to the production search engine/document retrieval system 152. The product search engine/document retrieval system 152 may include, e.g., but is not limited to, a firewall 126, which may be coupled to one or more load balancers 114a, 114b (which may alternatively run on a general purpose computer such as, e.g., but not limited to, web server 102a, 102b, 102c). Load balancers 114a, 114b, according to an exemplary embodiment, may be coupled to a web servers 102a, 102b, and 102c. Web servers 102a-c may be mesh coupled to one or more application servers 116a, 116b, and 116c, each of which may include and/or may access one or more production databases 122, 124, which may correspond to databases 122, 124, of development system 150. Web servers 102a-c (or collectively 102), in an exemplary embodiment, may perform load balancing functions by transferring client user requests to one or more of the application servers 116a-116c according to a series of semantics and/or rules. The databases 122, 124, which may be coupled to application servers 116a-116c may be updated periodically by a process 142, according to an exemplary embodiment, which may include transmitting from and to and/or synchronizing data between databases 122, 124 of development system 150 with databases 122, 124 of production system 152 coupled to application servers 116a-116c.

As shown, in an exemplary embodiment, application servers 116a-c may include a bid engine 118, according to an exemplary embodiment, which may be used to calculate bids, costs per click, sorting bids and/or search listings, etc.

As shown, in an exemplary embodiment, application servers 116a-c may include a database management system (DBMS) 120, according to an exemplary embodiment. DBMS 120 may manage databases 122, 124, which may each include a plurality of records, where each record may include, in turn, a plurality of fields, in an exemplary embodiment. As shown, in an exemplary embodiment, application servers 116a-c may include a database management system (DBMS) 120.

In an exemplary embodiment of the invention, the advertisers 132 may be any type of advertisers who would like their search listings displayed by the web server 102a, b. Search listings may include, e.g., but not limited to, website links, advertising links, advertising material, advertising banners, sale items, pictures relating a sale item, etc. The advertisers 132, in an exemplary embodiment, may be seeking to have search listings prominently displayed, and/or listed, on, e.g., a website, etc., in response to, e.g., but not limited to a search query, which may include, e.g., but not limited to, a keyword search by the users 130. The advertisers 132 may typically have an advertising budget from which they may provide, e.g., but not limited to, a bid budget, which may be a budget associated with a time period such as, e.g., but not limited to, daily, weekly and/or monthly bid budget according to various exemplary embodiments of the invention. The users 130 may represent any user searching by keyword, including, e.g., but not limited to, various consumers, retailers, etc. of goods who may rely on keyword searches to find various websites that may have desired goods and/or services.

The web server 102a, b, c may provide an interface for advertiser users 132 through advertiser user devices 108, 110. The web server 102a, b, c may receive information, including, e.g., but not limited to, information relating to bids for placement of search listings, from each of the advertisers 132. In an exemplary embodiment of the invention, the bids received from the advertisers 132 may be associated with individual keywords and/or groups of keywords. In another exemplary embodiment of the invention, the bids may be associated with the price for a click-though that a search listing of the advertiser 132 receives. In yet another exemplary embodiment of the invention, the bids may be associated with a time period, e.g., but not limited to, a daily, weekly, and/or monthly, etc., period, associated with a search listing or a keyword.

The web server 102a, b, c, may also provide an interface for users 130 through user devices 104 and 106. The web server 102a, b, c, may receive search queries from users 130. These search queries may include search keywords according to an exemplary embodiment. The web server 102a, b may also record website traffic, including the number of click-throughs for a search listing, e.g., but not limited to, the number of times a link has been clicked on by users 130. In response to keywords entered by users 130 in their search query, the web server 102 may display the search listings, e.g., but not limited to, advertisements, advertiser website links, and/or other content, and may communicate information pertaining to, e.g., but not limited to, click-throughs to a database 122, 124.

The bid engine 118 may include functionality for determining the order in which search listings may be displayed in an exemplary embodiment. In various exemplary embodiments of the invention, the ordering of the search listings may be based upon the advertiser 132 who may bid highest per keyword, or the advertiser 132 who has the largest budget such as, e.g., but not limited to, a monthly, weekly, and/or daily etc. budget. In some exemplary embodiments of the invention, these bids may be updated and may be resubmitted at certain predetermined time intervals, such as, e.g., but not limited to, every day, week or on a monthly basis, etc. The order database 122 may be used to calculate and/or store the order of search listings to be shown in response to a keyword selected by the users 130, according to one exemplary embodiment. The ordering of the search listings may be determined by the bid engine 118 using any of various data records, various fields. The records database 124 may store information relating to the advertisers 132, such as, e.g., but not limited to, the advertiser's current daily, weekly or monthly budget for keywords, a listing of keywords, as well as, e.g., but not limited to, a log of the number of click-throughs (e.g. clicks that each advertiser's website link may have received), and/or the number of sale-throughs, call-throughs, etc. The information from the database 124 may be utilized by the bid engine 118 when updating the ordering of the search listings according to an exemplary embodiment.

In operation, the advertisers 132 may select a manual and/or automatic bidding option according to an exemplary embodiment. In the manual bidding option, advertisers 132 can bid on keywords on a per display, per click-through, per call-through, per sale-through, etc. basis by accessing the web server 102a, b, according to one exemplary embodiment. The advertisers 132 may be presented with a keyword management screen and can manually enter bids for one or more keywords. These bids may be received by the web server 102a, b and may be stored in the records database 124. The bid engine 118 may sort each of the bids for the same keyword from highest to lowest bid according to their amount in one exemplary embodiment. This sorting may be stored in the order database 122. When a user 130 enters a keyword search query, the web server 102a, b may parse and process the query, provide a list of the advertisers and their ads (which may include, e.g., bit not limited to, content etc.) webpage links in the rank order stored in the order database 122. Thus, the customer may see the webpage link of the highest bidder first, followed by the other bidders in descending order, according to one exemplary embodiment. The web server 102a, b may also act as a traffic gauge and record the number of, e.g. click-throughs, call-throughs, sale-throughs, etc., made by the users 130. According to an exemplary embodiment, the advertisers 132 may then be charged for each click-through, call-through, sale-through, etc. to their respective links and the advertiser's budget may be decreased by the amount of the bid cost, which may be cost-per-click (CPC), cost-per-call, cost-per-sale, etc. In an exemplary embodiment, the number of clicks per link, call-throughs, or sale-throughs, may be stored in the database 124 in order to calculate how much each advertiser may owe the website operator. At certain predetermined time intervals, an advertiser's budget balance, such as, e.g., but not limited to, daily balance, may be recalculated to reflect the deductions for payments to the website operator. In addition, if an advertiser's budget (such as, e.g., but not limited to, daily or monthly) has been exhausted, or, in an exemplary embodiment, if they fall below a certain predetermined amount, his or her advertisements may no longer be displayed on the website, or may be replenished according to an exemplary replenishment authorization. The invention may allow advertisers to update and/or revise their bids at certain predetermined time intervals and/or periodically, and/or a periodically, etc.

In the automatic bidding mode of operation, each advertiser 132 may access the web server 102a, b and may bid on one or more keywords. In an exemplary embodiment, the bids for each keyword may not be on a manual, but instead may calculated automatically based on a budget having an associated time period such as, e.g., but not limited to, a weekly, daily and/or monthly budget or other predetermined time interval. In an exemplary embodiment, the monthly budgets may be received by the web server 102a, b and may be stored in the database 124. In the exemplary embodiment, a daily budget may be calculated daily based on the balance of the monthly budget. For example, the daily budget may be calculated based on the amount of the monthly budget remaining divided by the number of days remaining in the month. Thereafter, the bid engine 118 may calculate the bid amounts for each search listing based on the balance of the daily budget. In an exemplary embodiment, this calculation may occur every 15 minutes. The bid engine 125 may also sort the bids from the highest to lowest and this order may be stored in the database 130. In one exemplary embodiment of the invention, the advertiser with the lowest daily budget balance may be given the lowest autobit amount, which in some embodiments, may be 5¢, 10¢, 15¢, 20¢, etc. For all others, the auto bid amount may be calculated, in the increasing order of the daily budget balance, by incrementing the budget balance by an autobid increment amount, which in some embodiments may be e.g. 1¢, 2¢, 5¢, etc. Thus, as an example, the advertiser with the lowest daily budget balance may be assigned a bid per click-thorough of 20¢, the next lowest bidder may be assigned a bid per click-through of 21¢, the next lowest bidder may be assigned a bid per click-through of 22¢ and so on. This process may continue until a maximum autobid amount, which may be e.g. $1.00, has been reached. In an exemplary embodiment, if the maximum autobid amount is reached, the search listing with the biggest autobid amount may be set to the maximum autobid amount and all other autobids may be decremented until the minimum amount is reached. Thereafter, in an exemplary embodiment, the remaining autobid amounts may be set to the minimum autobit amount.

As mentioned above, the system may calculate a daily balance for each of the advertisers/bidders. In an exemplary embodiment, for new advertisers/bidders, the sub budget balance such as, e.g., but not limited to, daily balance may be calculated by taking a remaining budget for a given time period, and dividing by the number of sub-time periods remaining within the given time period=(monthly budget/days left in month). In that embodiment, for all other advertisers/bidders, the daily balance may be =(monthly budget−amount spent this month)/days left in month. In another embodiment, a monthly budget may be calculated for a one-month period beginning with the day of registration, and that day may become the beginning of all subsequent monthly periods for that user. In that embodiment, the daily balance for all bidders/advertisers may be calculated as (monthly budget−amount spent this month)/days left in month. The daily balance may be the amount that advertisers may have left to spend in a day. In an exemplary embodiment, each click-through to an advertiser's website link may subtract the bid cost per click-through from the daily balance. In other exemplary embodiment, there may be an additional user account associated with the bidder/advertiser, and the click-throughs may be deducted directly from the user account, which may be later used to calculate the daily budget balance.

Exemplary embodiments discussed herein use click-throughs as an example of the method of charging the advertisers/bidder. However, other methods such as, but not limited to, call-throughs, sale-throughs, etc. can also be used.

The users 130 may access the web server 102a in order to conduct keyword searches by entering search queries at, e.g., but not limited to, a search engine. In response to a keyword search, the web server 102a, b may display the web links for each of the advertisers that may have placed a bid on the selected keyword. The advertiser's website links may be listed in the order of the highest bidder to the lowest bidder as may have been determined above. The users 130 may click-thorough the website links of any of the displayed advertisers 132. The web server 102a, b may record the number of clicks that each website link may receive and may record this information in the database 124. This information may be used to bill the advertisers 132 because payment to the website operator may be based upon the number of clicks through to their websites made using the website links.

In an exemplary embodiment the automatic bid of the invention, the order in which the advertiser website links may be displayed may be recalculated and may be reordered at certain predetermined time intervals, which may be periodic, and or aperiodic, etc. In one exemplary embodiment, for example, the bid amounts may be recalculated daily, hourly, every 15 minutes, etc. The bids may be recalculated based upon the daily budget balance after the payments to the website operator may be deducted from the daily budget. The payments to the website operator may be based upon the bid per click-through and the number of click-throughs to the advertiser's website. Thus, according to one exemplary embodiment the updated daily balance may be calculated as follows:
Updated daily balance=current daily balance−(Number of click-throughs for advertiser's link*bid per each click-through)

In accordance with an exemplary embodiment of the invention, the bid engine 118 may periodically calculate the updated daily balance at pre-determined time intervals. In order to make such calculations, the bid engine 118 may access the previous bid information, including each advertiser's daily budget, as well as the number of click-throughs per advertiser from the records database 135. Further, as described above, the bid engine 118 may calculate each advertiser's updated daily budget after deductions may be made to account for the click-throughs. Other factors may also go into the recalculation of the bids, including, e.g., but not limited to, certain minimum bid increment rules, etc. Once the ads of the advertisers 132 have been reordered, in view of the updated daily balance calculations, for example, the ads may be each assigned a bid per click-through that may start with the advertiser with the lowest remaining budget and may ascend therefrom as discussed earlier. In an exemplary embodiment, the system may also remove those advertisers who have depleted their daily and/or monthly budgets and/or may replenish depleted budgets as pre-authorized.

In this manner, the listing of the advertisers may be dynamic and may be responsive to the number of click-throughs that each advertiser may receive. If an advertiser 132 receives a large number of click-throughs, his or her budget may become depleted relative to other advertisers 132. Thus, the advertiser's recalculated bid maybe lower relative to the other advertisers 132 and thus his or her advertisement to drop from the list of advertisers. An example follows:

### Example A

| Initial Order of Advertisers | Bid Per Click-Through | Daily Budget |
|---|---|---|
| Advertiser A | 17¢ | $50.00 |
| Advertiser B | 16¢ | $48.00 |
| Advertiser C | 15¢ | $47.00 |

Advertiser A, according to one exemplary embodiment, may receive 100 click-throughs in 15 minutes; Advertiser B may receive 5 click-throughs in 15 minutes and Advertiser C may receive 0 click-throughs in 15 minutes. The bid engine 118 may recalculate the bid and daily budget based, upon these clicks. At this point, according to an exemplary embodiment, the daily budget of Advertiser A may be down to $33.00 per day, while Advertiser B may have a remaining advertiser budget of $47.20 and Advertiser C may have a remaining budget of $47.00. Thus, the system in accordance with an exemplary embodiment of the invention may re-order the advertisers 132 based upon their updated daily budgets. Because, Advertiser B now has the largest available daily budget, he or she may now be listed on the top of the list of advertisers 132. Thus, the listing may be revised as follows:

| Revised Order of Advertisers | Remaining Daily Budget |
|---|---|
| Advertiser B | $47.20 |
| Advertiser C | $47.00 |
| Advertiser A | $33.00 |

In this example, the daily balance may be continuously recalculated and the advertisers 132 may be reordered again, e.g., but not limited to, in 15 minutes. In this manner, in an exemplary embodiment, the order of advertisers may be dynamic and/or capable of frequent change. If a particular advertiser may want to remain at, or near, the top of the list of advertisers, he or she may need to provide a very high daily budget to account for a lower recalculation of the daily budget in the event that that particular advertiser 132 may receive a high volume of website traffic. According to another exemplary embodiment a featured bid may be used to agree to pay for placement above the other highest bidders.

### Exemplary Embodiment of a Method of Present Invention

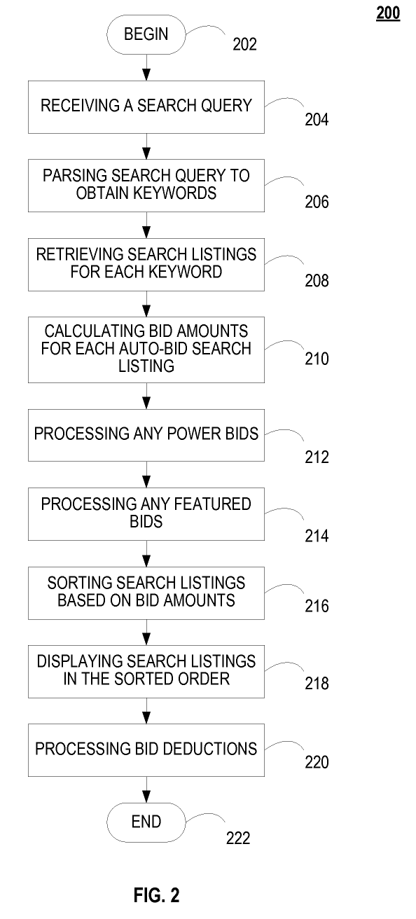

FIG. 2 depicts an exemplary embodiment of a flow diagram 200. Flow diagram 200, as depicted in FIG. 2, may begin with 202 and may continue, in an exemplary embodiment, to 204. In an exemplary embodiment, a page including, e.g., but not limited to, a search field may be presented to a user operating a computing device, e.g., but not limited to, a computer that may be connected to a web server via, e.g., but not limited to, the Internet.

The flow diagram 200 may continue with 204, where a search query may be received. The search query may include one or more keywords.

From 204, as illustrated in FIG. 2, flow diagram 200 may continue with 206. In 206, the search query received in 204 may be parsed into individual keywords. In an exemplary embodiment, an individual keyword may be more than one word in length.

From 206, as illustrated in FIG. 2, flow diagram 200 may continue with 208. In 208, in an exemplary embodiment, a search may be conducted for the individual keywords to retrieve search listings that correspond to the individual keywords. In one exemplary embodiment, separate searches may be conducted for each individual keyword. Various search techniques may be used to conduct the search for the search listings. In one exemplary embodiment, each search listing may already be associated with a keyword stored in a storage medium. In other embodiments, search listings may be searched dynamically for matches with the keywords.

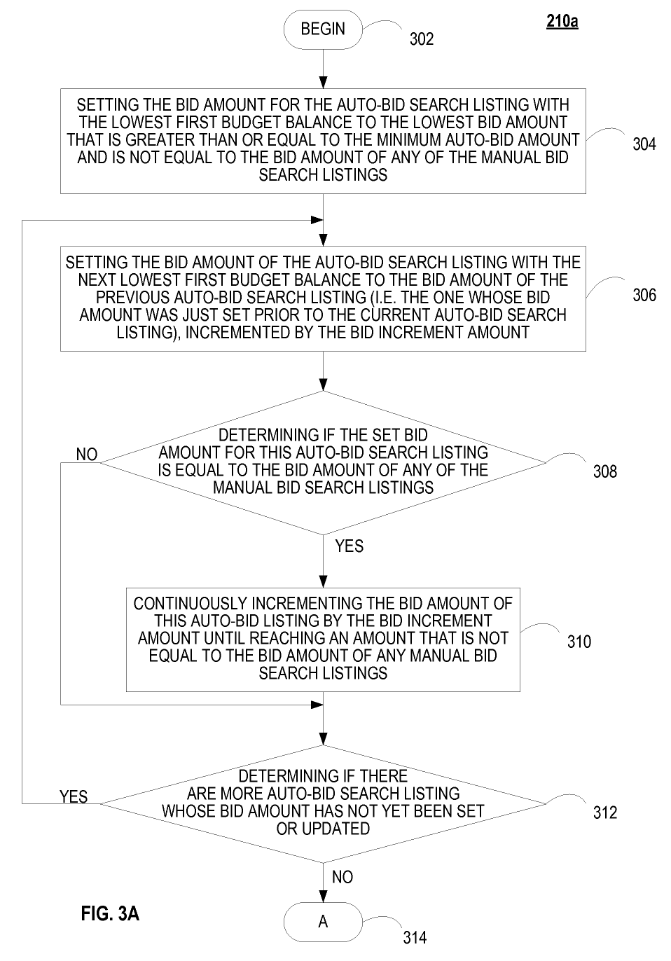

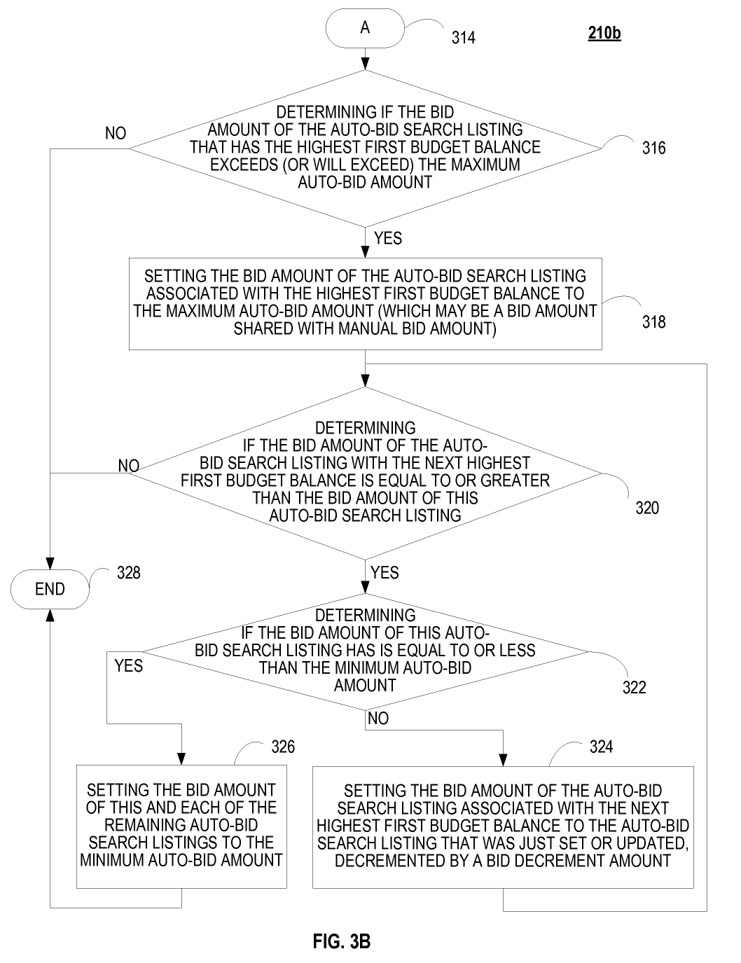

From 208, as illustrated in FIG. 2, flow diagram 200 may continue with 210. In 210, in an exemplary embodiment, the bid amount associated with each auto-bid search listing may be calculated. In an exemplary embodiment, the bid amount may be associated with the amount that would be charged to, e.g., but not limited to, an advertiser, upon the search listing being displayed in the search results (i.e. pay-per-listing). In an alternative exemplary embodiment, the bid amount may be associated with the amount that would be charged to, e.g., but not limited to, an advertiser, upon the search listing being clicked on by the user (i.e. pay-per-click). In yet another exemplary embodiment, the bid amount may be associated with, e.g., but not limited to, charges associated with a click that would lead to e.g., but not limited to, an actual sale (pay-per-sale), a call to a sales representative (pay-per-call), a visit to the advertiser's site for a certain time period, etc. The details of calculating the bid amount associated with each auto-bid search listing are discussed in detail below with reference to FIGS. 3A-B and 4A-D.

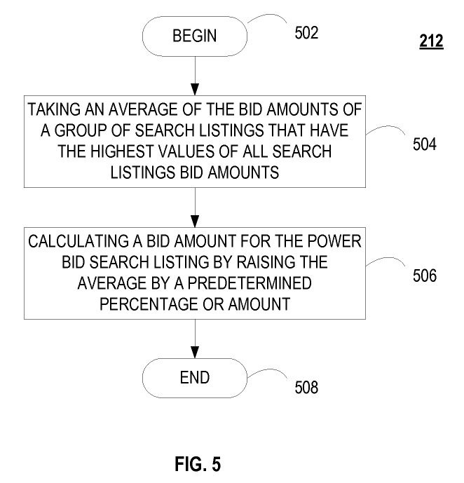

From 210, as illustrated in FIG. 2, flow diagram 200 may continue with 212. In 212, in an exemplary embodiment, the power bids, if any, may be processed. In an exemplary embodiment, the bid amount associated with the power bid search listings may be calculated. The details of an exemplary embodiment of processing the power bids are discussed in detail below with reference to FIG. 5.

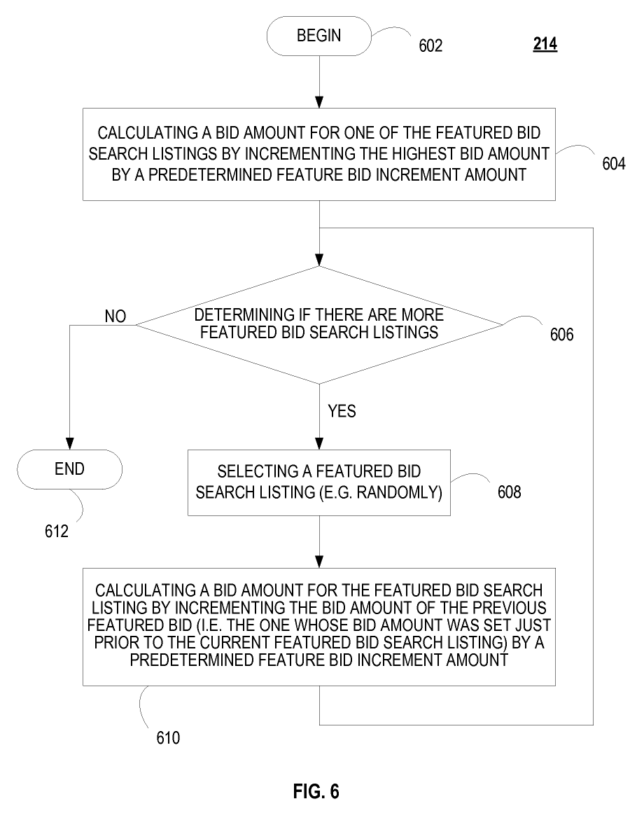

From 212, as illustrated in FIG. 2, flow diagram 200 may continue with 214. In 214, in an exemplary embodiment, the featured bids, if any, may be processed. In an exemplary embodiment, the bid amount associated with the feature bid search listings may be calculated. In an exemplary embodiment, where the featured bids may be calculated after the power bids, the featured bids may have the higher bid amounts that the power bids. The details of exemplary embodiment of processing the featured bids are discussed in detail below with reference to FIG. 6.

From 214, as illustrated in FIG. 2, flow diagram 200 may continue with 216. In 216, in an exemplary embodiment, the search listings may be sorted according to their bid amounts. In an exemplary embodiment including featured bids, power bides, auto bids, and manual bids, where power bid amounts may be calculated after the auto bid amount and featured bid amounts may be calculated after the power bid amounts, the search listings may be sorted in the order of featured bids, followed by power bids, followed by auto and manual bids. In alternative exemplary embodiments, the power bids may have higher placements than featured bids.

From 216, as illustrated in FIG. 2, flow diagram 200 may continue with 218. In 218, in an exemplary embodiment, the search listings may be displayed in the sorted order. In one exemplary embodiment, the sorting may take place as the search listings are being displayed. In an exemplary embodiment, the search listings may be displayed as website links. In an alternative exemplary embodiment, the search listings may be displayed as, e.g., but not limited to, a list of items, list of images, list of data, items for sale, phone listings, etc. In an exemplary embodiment, the featured search listings may be displayed in a manner or format that would distinguish the featured search listings from the other listings. Similarly, the power bid search listings, auto bid search listings, and/or manual bid search listings may be displayed in a different manner or format to distinguish them from each or all other listings.

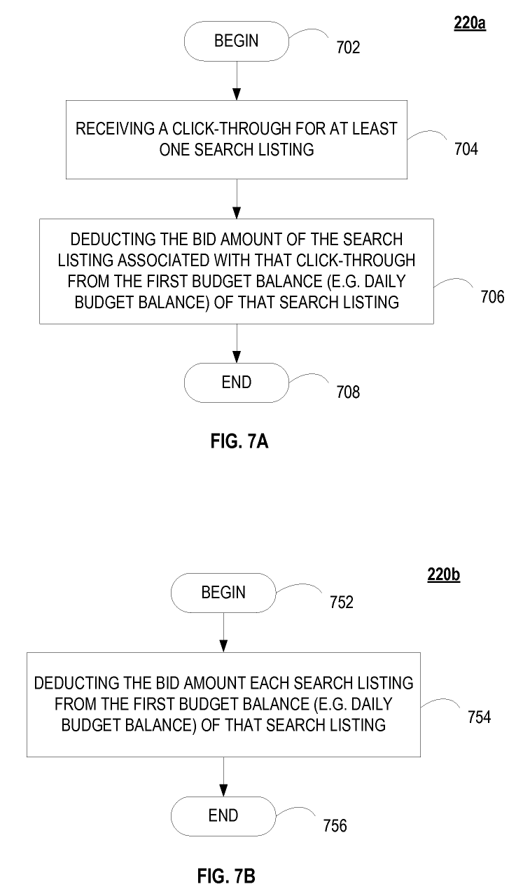

From 218, as illustrated in FIG. 2, flow diagram 200 may continue with 220. In 220, in an exemplary embodiment, the bid deductions may be processed. In an exemplary embodiments, where bid amounts for search listings correspond to, e.g., but not limited to, a pay-per-click, pay-per-call, pay-per-sale, etc., the bid amounts may be deducted from, e.g., but not limited to, a corresponding budget, when a user, e.g., but not limited to, clicks on the search listing, calls the owner or advertiser associated with the search listing, makes a sale from the owner or advertiser, etc. In other exemplary embodiment, where bid amounts correspond to e.g., but not limited to, a pay-per-listing, the bid amounts may be deducted for each search listing that may be displayed from, e.g., but not limited to, a corresponding budget. The details of exemplary embodiment of processing the bid deductions are discussed in detail below with reference to FIG. 7A-B.

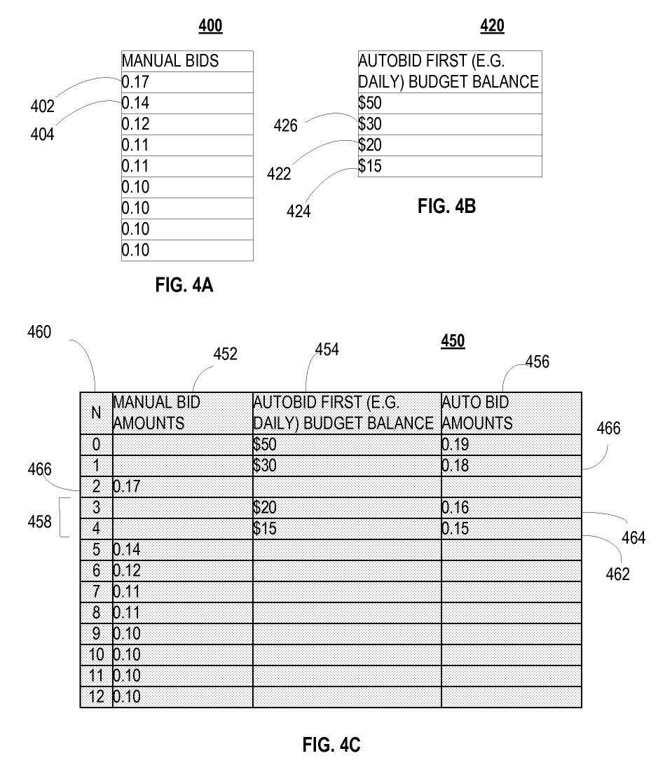

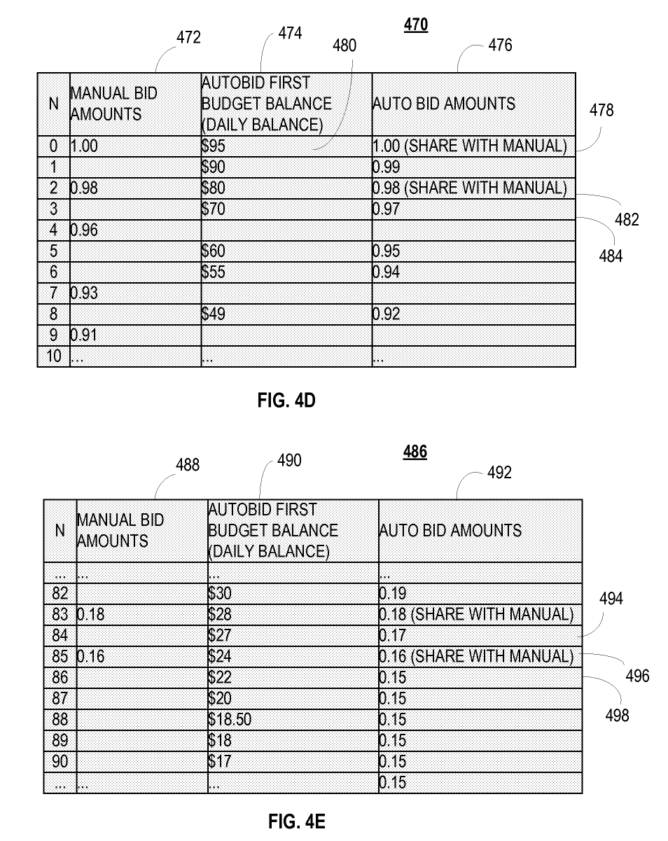

FIGS. 3A and 3B set forth an exemplary embodiment of an exemplary flow diagram 210 for calculating the bid amounts for the auto-bid search listings in accordance with an exemplary embodiment of the invention. See the description with reference to FIGS. 4A-D below regarding the calculation of bid amounts for auto-bid search listings as well as sorting the auto-bid and manual search listings, according to an exemplary embodiment of the invention.

Flow diagram 210a, as depicted in FIG. 3A, may begin with 302 and may continue, in an exemplary embodiment, to 304. In 304, in an exemplary embodiment, the bid amount for the auto-bid search listings that has the lowest first budget balance to the lowest possible bid amount that may be greater than or equal to the minimum auto-bid amount and is not equal to the bid amount of any of the manual bid search listing. In an exemplary embodiment, the minimum auto-bid amount may be, e.g., but not limited to, 15 cents, 20 cents, 25 cents, and/or 50 cents, etc.

From 304, as illustrated in FIG. 3A, flow diagram 210a may continue with 306. In 306, in an exemplary embodiment, the bid amount of the auto-bid search listing that has the next lowest first budget balance may be processed. In an exemplary embodiment, the bid amount of the auto-bid search listing currently being processed may be set to the bid amount of the previous auto-bid search listing (i.e. the one whose bid amount was just set prior to the current auto-bid search listing), incremented by the bid increment amount. In an exemplary embodiment, the bid increment amount may be 1 cent.

From 306 as illustrated in FIG. 3A, flow diagram 210a may continue with 308. In 308, in an exemplary embodiment, a determination may be made as to whether the bid amount that was just set for the auto-bid search listing currently being processed may be equal to the bid of any of the manual bid search listings. If yes, in an exemplary embodiment, flow diagram 210a may continue with 310 before continuing on to 312. Otherwise, in an exemplary embodiment, flow diagram 210a may continue directly to 312.

In 310, in an exemplary embodiment, the bid amount of the auto-bid search listing currently being processed may be continuously incremented by the bid increment amount until a bid amount may be reached that is not equal to the bid amount of any manual bid search listings.

In 312, in an exemplary embodiment, a determination may be made as to whether there may be any more auto-bid search listings whose bid amount has not yet been set or updated. If yes, in an exemplary embodiment, flow diagram 210a may continue with looping back to 306 in order to process the remaining auto-bid search listings. Otherwise, in an exemplary embodiment, flow diagram 210a may continue with 314.

Flow diagram 210b, as depicted in FIG. 3B, may begin with 314 and may continue, in an exemplary embodiment, to 316. In 316, in an exemplary embodiment, a determination may be made as to whether the bid amount of the highest first budget balance exceeds the maximum auto-bid amount. If no, the flow chart 210b may end with 328. Otherwise, in an exemplary embodiment, flow chart 210b may continue with 318.

In 318, in an exemplary embodiment, the bid amount of the auto-bid search listings associated with the highest first budget balance may be set to the maximum auto-bid amount. In an exemplary embodiment, the maximum auto-bid amount may be $1.00. In an exemplary embodiment, the bid amount for this auto-bid search listing may be the same as an existing manual bid amount, in which case the value of the bid amount may be shared between this auto-bid search listing and a manual bid search listing.

From 316, as illustrated in FIG. 3B, flow diagram 210b may continue with 320. In 320, in an exemplary embodiment, a determination may be made as to whether the bid amount of the auto-bid search listing that has the next highest first budget balance may be equal to or greater than the bid amount of the current auto-bid search listing whose bid amount was just set or updated. If no, flow diagram 210b may end with 328. Otherwise, in an exemplary embodiment, flow chart 210b may continue with 322.

In 322, in an exemplary embodiment, a determination may be made as to whether the bid amount of the current auto-bid whose bid amount was just set or updated may be equal to or less than the minimum auto-bid amount. In an exemplary embodiment, the minimum auto-bid amount may be 15 cents. If no, in an exemplary embodiment, flow diagram 210b may continue with 324. Otherwise, in an exemplary embodiment, flow chart 210b may continue with 326.

In 324, in an exemplary embodiment, the bid amount of the auto-bid search listing that has the next highest first budget balance may be set to the current auto-bid search listing that was just set or updated, decremented by a bid decrement amount. In an exemplary embodiment, the bid decrement amount may be equal to the bid increment amount. In an exemplary embodiment, the bid decrement amount may be 1 cent. From 324, flow diagram 210b may loop back to 320, where a determination may be made for the last set or updated auto-bid search listing.

In 326, in an exemplary embodiment, all the bid amount of the remaining auto-bid search listings may be set to the minimum auto-bid amount. From 326, the flow diagram 210b may end with 328.

FIGS. 4A through 4D set forth an example illustrating the sorting of auto-bid search listings and manual bid search listings in accordance with an exemplary embodiment of the invention.

FIG. 4A sets forth an exemplary list 400 of manual bids having exemplary bid amounts between 10 cents and 17 cents, according to an exemplary embodiment of the invention.

FIG. 4B sets forth an exemplary list 420 of auto bids having exemplary first budget balances between $15 to $50, according to an exemplary embodiment of the invention. In an exemplary embodiment, the first budget balance may be a daily budget. In another exemplary embodiment of the invention, the first budget balance may be associated with any other time period, e.g., but not limited to, hourly, weekly, monthly, annual, etc.

FIG. 4C sets forth an exemplary diagram 450 indicating an exemplary method of calculating bid amounts 454 associated with auto-bid search listings associated with the first budget balances in list 420 of FIG. 4B. In an exemplary embodiment, the minimum bid amount for auto bid search listings may be, according to an exemplary embodiment, 10 cents, 15 cents, 20 cents, etc., and/or bid increment amount may be 1 cent, 2 cents, etc. In an exemplary embodiment, the list 400 of FIG. 4A correspond to column 452 in diagram 450, leaving one or more gaps 458 between any two non-consecutive manual bid amounts higher than the minimum bid amount. In an exemplary embodiment, each gap corresponds to the bid increment amount, thus there may be two slots 460 between the slots corresponding to manual bid amounts 402 (17 cents) and 404 (17 cents). In an exemplary embodiment, the list 420 of FIG. 4B correspond to column 454 in diagram 450, and column 465 represents the bid amounts calculated for each auto bid corresponding to each respective first budget balance of column 454. In an exemplary embodiment, starting with the lowest first budget balance 424 ($15), the auto bid amount 462 may be set to an amount greater than or equal to the minimum bid amount (15 cents) that does not have a manual bid 402, 404 associated with the auto bid amount 462, i.e., 15 cents. In the exemplary embodiment, the next auto bid amount 464 may be set to the previous auto bid amount 462, incremented by the bid increment amount (1 cent), so long as that there may be no manual bid 402, 404 may be associated with the bid amount 464, i.e., 16 cents. In the exemplary embodiment, the next auto bid amount 468 may be calculated similarly, i.e. 17 cents, but since the manual bid 466 already equals the newly calculated amount, auto bid amount 468 may be incremented by the bid increment amount until a bid amount may be obtained for which no manual bid 402, 404 exists.

FIG. 4D sets forth an exemplary diagram 470 indicating an exemplary method of calculating bid amounts 476, where any of the auto bid amounts 462, 464, 468 in FIG. 4C exceeds a maximum bid amount. In an exemplary embodiment of FIG. 4D, column 472 corresponds to manual bid amounts of column 452 of FIG. 4C, column 474 corresponds to auto bid first budget balance of column 454 of FIG. 4C, and column 476 corresponds to auto bid amounts of column 456 of FIG. 4C. In an exemplary embodiment, the maximum bid amount may be set to a predetermined amount, e.g., $1.00. In an exemplary embodiment, if there may be more auto bids than available slots, e.g., if the bid amount for any auto bids exceeds the maximum bid amount, then the value of the maximum auto bid amount 478 corresponding to the highest first budget balance 480 (e.g. $95) may be set to the maximum bid amount (e.g. $1.00). In an exemplary embodiment, the bid amount of the next highest first budget balance may be set to the previous bid amount, decremented by the bid decrement amount (e.g. $1.00−$0.01=$0.99). In an exemplary embodiment, this process may continue as long as the bid amount of the auto-bid having the next highest first budget balance may be greater than or equal to the auto-bid amount that was last calculated. In an exemplary embodiment depicted in FIG. 4D, the auto bid amount 478, which may have been initially calculated as $1.02, may be set to $1.00, and the auto bid amount 482, which may have been initially calculated as $1.01, may be set to $0.99, and so on. In the exemplary embodiment, however, after the auto bid amount 482 may be set from 0.99 to 0.98, the auto bid amount 484 may remain at 0.97 because the auto bid amount 484 may be less than the new auto bid amount 484.

FIG. 4E sets forth an exemplary diagram 486 indicating an exemplary method of calculating bid amounts 492, where, the auto bid amounts 478, 482, 484 in FIG. 4D, the bid amount reaches the minimum auto bid amount. In an exemplary embodiment depicted in FIG. 4E, the auto bid amount 494 may be decremented to $0.17 and the auto bid amount 496 may be decremented to $0.16. In an exemplary embodiment, once the auto bid amount 498 may be reached, the auto bid 498 may no longer be decremented since auto bid 498 may be already set at $0.15, which in this example may be the minimum auto bid amount. Thereafter, all remaining auto bid values may be set at the minimum auto bid amount.

FIG. 5 depicts an exemplary embodiment of an exemplary flow diagram 212 illustrating the processing of power bid search listings in accordance with an exemplary embodiment of the invention.

Flow diagram 212, as depicted in FIG. 5, may begin with 502 and may continue, in an exemplary embodiment, to 504, where, in an exemplary embodiment, an average of the bid amounts of a group of search listings that have the highest bid amount values out of all search listings may be taken.

From 504, the flow diagram 212 may continue with 506, where, in an exemplary embodiment, the bid amount for the power bid search listing may be calculated by raising the average by a predetermined percentage. In another exemplary embodiment, the bid amount for the power bid search listing may be calculated by raising the average by a predetermined amount. The flow diagram 212 may then end at 508.

FIG. 6 depicts an exemplary embodiment of an exemplary flow diagram 214 illustrating the processing of featured bid search listings in accordance with an exemplary embodiment of the invention.

Flow diagram 214, as depicted in FIG. 6, may begin with 602 and may continue, in an exemplary embodiment, to 604, where, in an exemplary embodiment, a featured bid search listing may be selected randomly (if there may be more than one featured bids) and the bid amount for the featured bid search listing may be calculated by incrementing the highest bid amount (i.e. the highest bid amount of any auto-bids, manual-bids, and/or even power bids) by a predetermined feature bid increment amount. In an exemplary embodiment, the predetermined feature bid increment amount may be 1 cent, 2 cents, 5 cent, etc.

Flow diagram 214 may continue with 606, in which, in an exemplary embodiment, a determination may be made as to whether there may be more featured bid search listings to be processed. If not, in an exemplary embodiment, flow diagram 214 may end at 612. Otherwise, in an exemplary embodiment, flow diagram 214 may continue at 608, in which, in an exemplary embodiment, another featured bid may be selected randomly.

Flow diagram 214, in an exemplary embodiment, may then continue with 610, in which, in an exemplary embodiment, the bid amount for the featured bid search listing may be calculated by incrementing the value of the previous featured bid by the predetermined feature bid increment amount. From 610, flow diagram 214 may then loop back to 606, where a determination may again be made as to whether there may be any more featured bid search listings to be processed.

FIGS. 7A-B depicts an exemplary embodiment of an exemplary flow diagram illustrating the processing of bid deductions in accordance with an exemplary embodiment of the invention.

FIG. 7A depicts an exemplary embodiment of an exemplary flow diagram 220a illustrating the processing of e.g., but not limited to, click-throughs, in accordance with an exemplary embodiment of the invention.

Flow diagram 220a, as depicted in FIG. 7A, may begin with 702, in which, in an exemplary embodiment, the search listings may have already been displayed to a user and a waiting may be initialized for the user's click-through of one of the search listing.

Flow diagram 220a may continue, in an exemplary embodiment, to 704, where, in an exemplary embodiment, a click-through for at least one search listing may be received.

Flow diagram 220a may then continue, in an exemplary embodiment, to 706, where, in an exemplary embodiment, the first budget balance (e.g., but not limited to, the daily balance) may be updated by deducting the bid amount of the search listing clicked-through from the first budget balance. The flow diagram 220a may then end, in an exemplary embodiment, with 708.

In other exemplary embodiments, instead of a click-through, the first balance budget may be deducted when there is, e.g., but not limited to, a call-through (e.g. when the user makes a call to a sales representative after clicking on the link), a sale-through (e.g. when the user actually purchases an item from the website).

FIG. 7B depicts an exemplary embodiment of an exemplary flow diagram 220b illustrating the processing of bid amount deductions when, e.g., but not limited to, a pay-per-listing has been adapted, in accordance with an exemplary embodiment of the invention.

Flow diagram 220b, as depicted in FIG. 7B, may begin with 752 and, in an exemplary embodiment, may continue to 754. In 754, in an exemplary embodiment, the bid amount of all search listings (e.g. all that were displayed) may be deducted from their corresponding first budget balance. Flow diagram 220b, may then, in an exemplary embodiment, end at 756.

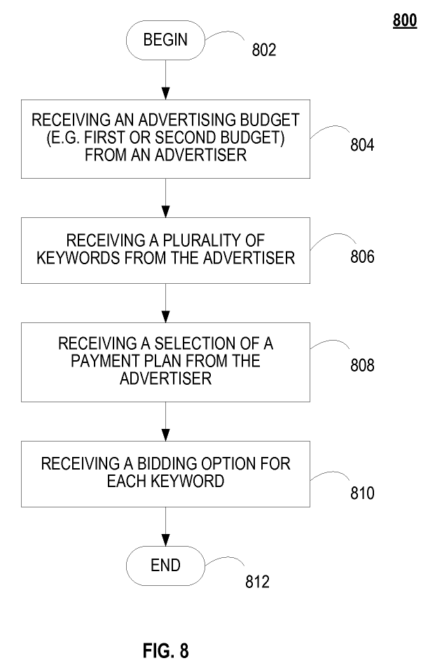

FIG. 8 depicts an exemplary embodiment of an exemplary flow diagram 800 illustrating the processing of an advertiser's registration or account update in accordance with an exemplary embodiment of the invention. Flow diagram 800 may start, in an exemplary embodiment, with 802, which may include, in an exemplary embodiment, presenting an advertiser with a login page where, e.g. but not limited to, he can apply for or register for an account or log into an existing account in order to add funds to his budget. Flow diagram 800 may then continue, in an exemplary embodiment, to 804.

In 804, in an exemplary embodiment, an advertiser's budget, which may be, e.g., but not limited to, the first and/or second budget, may be received from an advertiser. In an exemplary embodiment, the advertiser may be presented with an option to enter an amount which may represent, e.g. but not limited to, the first or second budget. In an exemplary embodiment, the advertiser may also be given an option to enter, e.g., but not limited to, a credit card number, bank account information, a debit card number, or other information enabling a financial transaction.

Flow diagram 800 may then continue, in an exemplary embodiment, to 806. In 806, in an exemplary embodiment, one or more keywords may be received from the advertiser. In an exemplary embodiment, the keywords may represent the search terms for which the advertiser may wish for his search listings to be included in the search.

Flow diagram 800 may then continue, in an exemplary embodiment, to 808. In 808, in an exemplary embodiment, a payment plan may be received from the advertiser. In an exemplary embodiment, a payment plan may represent the method of funding and/or updating e.g., but not limited to, the first and/or the second budget. In an exemplary embodiment, a payment plan may include, e.g., but not limited to, a term payment plan, a pay as you go plan, and/or a constant traffic plan.

In an exemplary embodiment, a term payment plan may include a periodic (e.g., but not limited to, daily, weekly, monthly, annual, etc) or aperiodic term which the payment may cover. In an exemplary embodiment, a term payment plan may be used for e.g., but not limited to, paying for bids associated with the advertiser's search listings. In an exemplary embodiment, the budget associated with the term payment plan may be updated by the advertiser at any time within the time period. In an exemplary embodiment, an auto-replenishment option may be available, so that if the budget balance falls under a predetermined amount, the funds can be automatically replenished from, e.g., but not limited to, a credit card or bank account of the advertiser. In an exemplary embodiment, the payment plan may be set to a term payment plan by default.

In an exemplary embodiment, a constant traffic plan may include a budget which may be automatically replenished. In an exemplary embodiment, the budget may be replenished every time the balance falls below a certain amount. In an exemplary embodiment, the auto-replenishment may provide a bonus equivalent to e.g., but not limited to, a certain percentage of the funds replenished.

According to an exemplary embodiment, an exemplary pay as you go plan may be chosen by an advertiser, if the advertiser wants to wait until the advertiser's account reaches a low balance and then the account may prompt the advertiser to manually enter a credit card to fund the advertiser's account, according to an exemplary embodiment. According to an exemplary embodiment, the search engine service provider may send the advertiser an alert such as, e.g., but not limited to, a message, an instant message, a short message system (SMS) message, a multimedia message system (MMS) message, and/or an electronic mail (email) notification, when the advertiser's account may be low on funds, and/or out of funds. Flow diagram 800 may then continue, in an exemplary embodiment, to 810. In 810, in an exemplary embodiment, a bidding option may be received from the advertiser. In an exemplary embodiment, a bidding option may be provided for each keyword individually. In an exemplary embodiment, alternatively, a bidding option may be provided for the advertiser's account as a whole and may apply to all keywords associated with that account.

In an exemplary embodiment, bidding options include, e.g., but not limited to, a power bid, an auto-bid, a manual bid, and a featured bid. In an exemplary embodiment, a manual bid may be an amount that the advertiser may specify as the bidding amount for a keyword or a search listing. In an exemplary embodiment, an auto-bid may be a bid amount that may be calculated based on a budget balance, as set forth in FIGS. 3 and 4. In an exemplary embodiment, a power bid may be a bid that may receive a higher placement than auto and manual bids, as set forth in FIG. 6. In an exemplary embodiment, a featured bid may be a bid that may receive a higher placement than all other bids and may be calculated by raising the highest bid, as set forth in FIG. 7. After 810, flow diagram 800 may then end at 812.

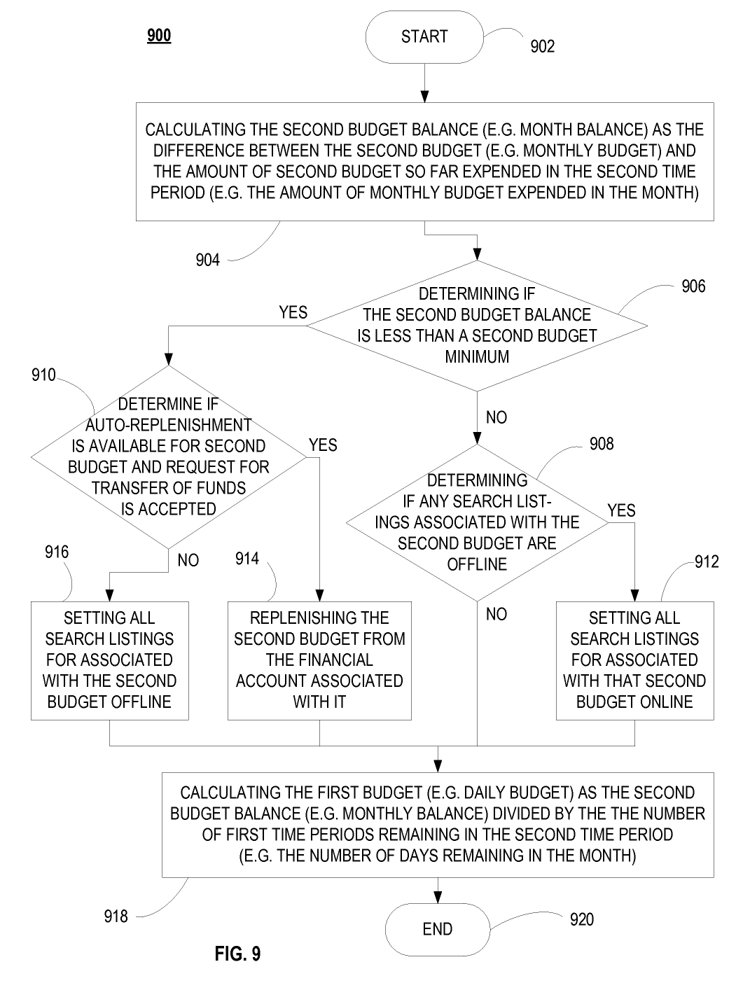

FIG. 9 depicts an exemplary embodiment of an exemplary flow diagram 900 illustrating the processing of the second budget (e.g. monthly budget) to calculate the first budget (e.g. daily budget) in accordance with an exemplary embodiment of the invention.

Flow diagram 900 may start, in an exemplary embodiment, with 902, which may include, in an exemplary embodiment, waiting for an event to occur which may trigger the start of flow diagram 900. In an exemplary embodiment, the trigger may be a new search request, which may aperiodically require calculating a new first and/or second budget balance. In an alternate exemplary embodiment, where the calculation of first and/or second budgets and/or budget balances may be done periodically, the triggering event may be a set time within that time period, e.g., but not limited to, the start of the day at midnight.

Flow diagram 900 may then continue, in an exemplary embodiment, with 904. In 904, in an exemplary embodiment, the second budget balance (e.g. monthly budget balance) may be calculated as the difference between the second budget (e.g. monthly budget) and the amount of second budget so far expended in the second time period (e.g. the amount of monthly budget so far expended in the current monthly period). Thus, the second budget balance may be calculated as:
second budget balance=second budget−amount of budget so far expended in second time period

Flow diagram 900 may then continue, in an exemplary embodiment, with 906. In 906, a determination may be made as to whether the second budget balance may be less than a second budget minimum. If so, flow diagram 900 may, in an exemplary embodiment, continue with 910. Otherwise, in an exemplary embodiment, flow diagram 900 may continue with 908.

The second budget minimum may be set at a positive amount, at zero, or at a negative amount. In an exemplary embodiment, where it may be desired to keep an advertiser's account online even if the advertiser's balance goes below zero, the second budget minimum may be set to, e.g., but not limited to, $−50, $−250, $−500, etc.

In 908, in an exemplary embodiment, a determination may be made as to whether the any search listings associated with the second budget (e.g. any of the advertiser's search listings) may be offline. If so, in an exemplary embodiment, flow chart 900 may continue with 912, in which the search listings may be set online. Otherwise, flow chart 900 may continue with 918.

At 918, the first budget (e.g. daily budget) may be calculated as the second budget balance (e.g. monthly budget) divided by the number of first time periods remaining in the second time period (e.g. the number of days remaining in the month). Thus, the first budget may be calculated as:
first budget=second budget balance/the number of first time periods remaining in the second time period

If at 906 it may be determined that the second budget balance may be below a second budget minimum, in an exemplary embodiment, flow diagram 900 may continue at 910, in which a determination may be made as to whether auto replenishment may be available for the second budget and, upon sending a request for transfer of funds, whether the request may be accepted. If so, in an exemplary embodiment, flow diagram 900 may continue with 914, in which the second account may be replenished using funds from a financial account, e.g., but not limited to, a bank or credit card, that may be associated with the second budget. Otherwise, flow diagram 900 may continue with 916, in which all search listings associated with the second account (e.g. all advertiser's search listings) may be set offline. After either 914 and/or 916, flow diagram 900 may continue with 918.

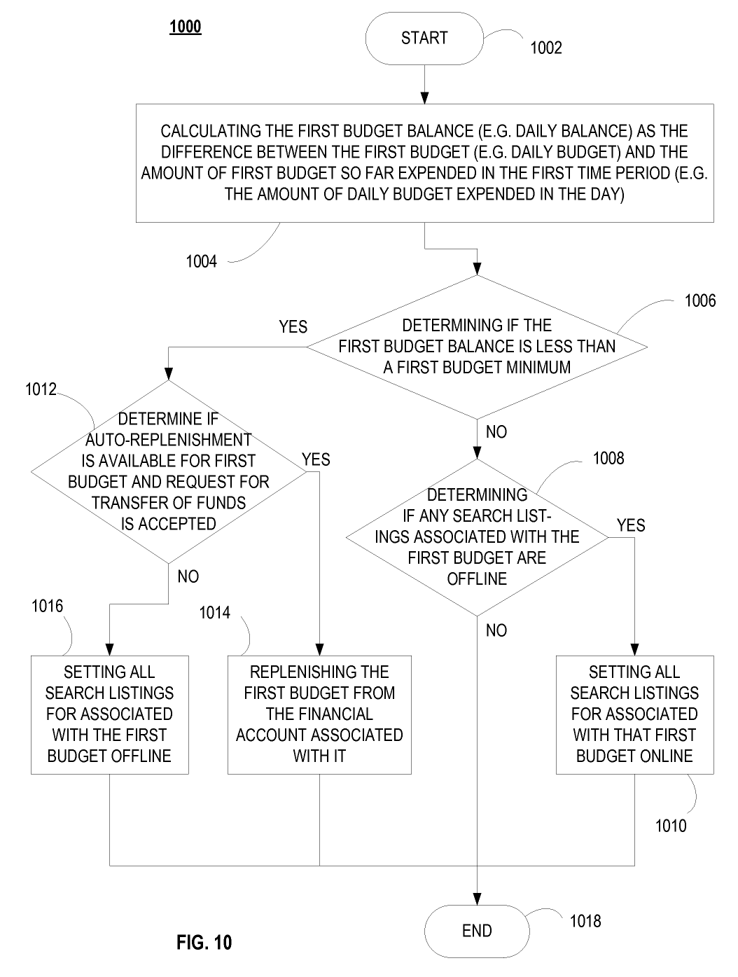

FIG. 10 depicts an exemplary embodiment of an exemplary flow diagram 1000 illustrating the processing of the first budget (e.g. daily budget) in accordance with an exemplary embodiment of the invention.

Flow diagram 1000 may start, in an exemplary embodiment, with 1002, which may include, in an exemplary embodiment, waiting for an event to occur which may trigger the start of flow diagram 1000. In an exemplary embodiment, the trigger may be a new search request, which may aperiodically require calculating a new first and/or second budget balance. In an alternate exemplary embodiment, where the calculation of first and/or second budgets and/or budget balances may be done periodically, the triggering event may be a set time within that time period, e.g., but not limited to, every minutes, every 15 minutes, every hour, etc.

Flow diagram 1000 may then continue, in an exemplary embodiment, with 1004. In 1004, in an exemplary embodiment, the first budget balance (e.g. daily budget balance) may be calculated as the difference between the first budget (e.g. daily budget) and the amount of first budget so far expended in the first time period (e.g. the amount of daily budget so far expended in the day). Thus, the second budget balance may be calculated as:
first budget balance=first budget−amount of first budget so far expended in first time period

Flow diagram 1000 may then continue, in an exemplary embodiment, with 1006. In 1006, a determination may be made as to whether the first budget balance may be less than a first budget minimum. If so, flow diagram 1000 may, in an exemplary embodiment, continue with 1012. Otherwise, in an exemplary embodiment, flow diagram 1000 may continue with 1008.

The first budget minimum may be set at a positive amount, at zero, or at a negative amount. In an exemplary embodiment, where it may be desired to keep an advertiser's account online even if the advertiser's balance goes below zero, the first budget minimum may be set to, e.g., but not limited to, $−10, $−25, $−100, etc.

In 1008, in an exemplary embodiment, a determination may be made as to whether the any search listings associated with the first budget (e.g. any of the advertiser's search listings) may be offline. If so, in an exemplary embodiment, flow chart 1000 may continue with 1010, in which the search listings may be set online. Otherwise, flow chart 1000 may end with 1018.

If at 1006 it may be determined that the first budget balance may be below a first budget minimum, in an exemplary embodiment, flow diagram 1000 may continue at 1012, in which a determination may be made as to whether auto replenishment may be available for the first budget and, upon sending a request for transfer of funds, whether the request may be accepted. If so, in an exemplary embodiment, flow diagram 1000 may continue with 1014, in which the second account may be replenished using funds from a financial account, e.g., but not limited to, a bank or credit card, that may be associated with the second budget. Otherwise, flow diagram 1000 may continue with 1016, in which all search listings associated with the first account (e.g. all advertiser's search listings) may be set offline for the remainder of the first time period. In an exemplary embodiment, if at 5 pm the daily balance falls below $−25, the search listings may be set offline for the remainder of the day until a new daily balance may be calculated at midnight. After either 1014 and/or 1016, flow diagram 1000 may continue with 1018.

Exemplary Embodiment of Computer Environment

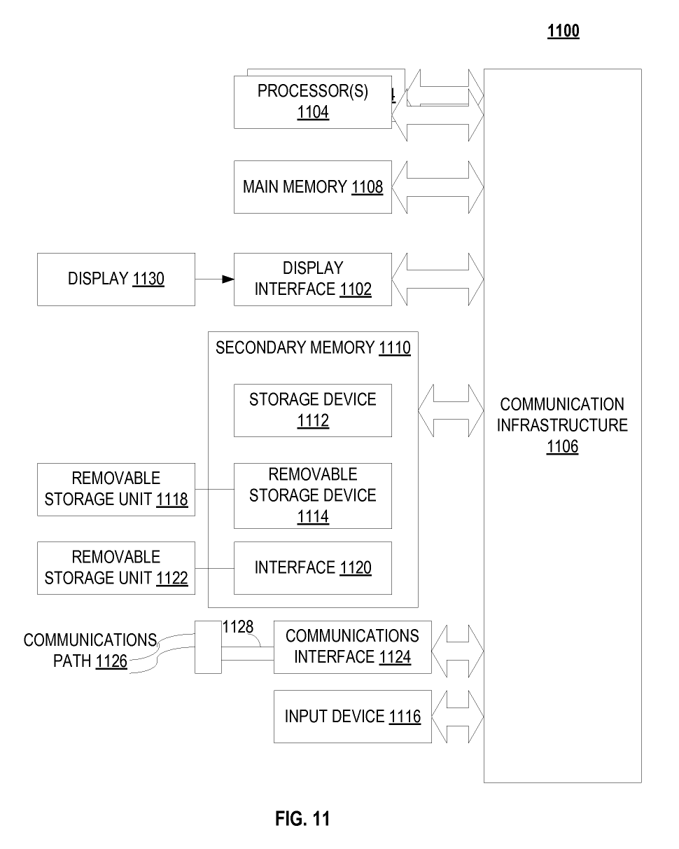

FIG. 11 depicts an exemplary computer system that may be used in implementing an exemplary embodiment of the present invention. Specifically, FIG. 11 depicts an exemplary embodiment of a computer system 1100 that may be used in computing devices such as, e.g., but not limited to, a client and/or a server, etc., according to an exemplary embodiment of the present invention. FIG. 11 depicts an exemplary embodiment of a computer system that may be used as client device 1100, or a server device 1100, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 1100 may be shown in FIG. 11, depicting an exemplary embodiment of a block diagram of an exemplary computer system useful for implementing the present invention. Specifically, FIG. 11 illustrates an example computer 1100, which in an exemplary embodiment may be, e.g., (but not limited to) a personal computer (PC) system running an operating system such as, e.g., (but not limited to) MICROSOFT® WINDOWS® NT/98/2000/XP/CE/ME/etc. available from MICROSOFT® Corporation of Redmond, Wash., U.S.A. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 1100 may be shown in FIG. 11. Other components of the invention, such as, e.g., (but not limited to) a computing device, a communications device, mobile phone, a telephony device, a telephone, a personal digital assistant (PDA), a personal computer (PC), a handheld PC, an interactive television (iTV), a digital video recorder (DVD), client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 11. Services may be provided on demand using, e.g., but not limited to, an interactive television (iTV), a video on demand system (VOD), and via a digital video recorder (DVR), or other on demand viewing system.

The computer system 1100 may include one or more processors, such as, e.g., but not limited to, processor(s) 1104. The processor(s) 1104 may be connected to a communication infrastructure 1106 (e.g., but not limited to, a communications bus, cross-over bar, or network, etc.). Various exemplary software embodiments may be described in terms of this exemplary computer system. After reading this description, it may become apparent to a person skilled in the relevant art(s) how to implement the invention using other computer systems and/or architectures.

Computer system 1100 may include a display interface 1102 that may forward, e.g., but not limited to, graphics, text, and other data, etc., from the communication infrastructure 1106 (or from a frame buffer, etc., not shown) for display on the display unit 1130.

The computer system 1100 may also include, e.g., but may not be limited to, a main memory 1108, random access memory (RAM), and a secondary memory 1110, etc. The secondary memory 1110 may include, for example, (but not limited to) a hard disk drive 1112 and/or a removable storage drive 1114, representing a floppy diskette drive, a magnetic tape drive, an optical disk drive, a compact disk drive CD-ROM, etc. The removable storage drive 1114 may, e.g., but not limited to, read from and/or write to a removable storage unit 1118 in a well known manner. Removable storage unit 1118, also called a program storage device or a computer program product, may represent, e.g., but not limited to, a floppy disk, magnetic tape, optical disk, compact disk, etc. which may be read from and written to by removable storage drive 1114. As may be appreciated, the removable storage unit 1118 may include a computer usable storage medium having stored therein computer software and/or data. In some embodiments, a “machine-accessible medium” may refer to any storage device used for storing data accessible by a computer. Examples of a machine-accessible medium may include, e.g., but not limited to: a magnetic hard disk; a floppy disk; an optical disk, like a compact disk read-only memory (CD-ROM) or a digital versatile disk (DVD); a magnetic tape; and a memory chip, etc.

In alternative exemplary embodiments, secondary memory 1110 may include other similar devices for allowing computer programs or other instructions to be loaded into computer system 1100. Such devices may include, for example, a removable storage unit 1122 and an interface 1120. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1122 and interfaces 1120, which may allow software and data to be transferred from the removable storage unit 1122 to computer system 1100.

Computer 1100 may also include an input device 1116 such as, e.g., (but not limited to) a mouse or other pointing device such as a digitizer, and a keyboard or other data entry device (not shown).

Computer 1100 may also include output devices, such as, e.g., (but not limited to) display 1130, and display interface 1102. Computer 1100 may include input/output (I/O) devices such as, e.g., (but not limited to) communications interface 1124, cable 1128 and communications path 1126, etc. These devices may include, e.g., but not limited to, a network interface card, and modems (neither are labeled). Communications interface 1124 may allow software and data to be transferred between computer system 1100 and external devices.

In this document, the terms “computer program medium” and “computer readable medium” may be used to generally refer to media such as, e.g., but not limited to removable storage drive 1114, a hard disk installed in hard disk drive 1112, and signals 1128, etc. These computer program products may provide software to computer system 1100. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms may be not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm may be here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

Description of an Exemplary Advertisement Placement Auctioning Process

In accordance with an exemplary embodiment of the invention, advertisers can place bids on certain keyword search terms. In response to the use of a certain keyword search term by a user, the website may display advertiser information, including advertiser website links and advertisement placements for those advertisers who have bid on that keyword. The highest bidding advertiser may receive the highest placement on the host website, while the remaining advertisers may be displayed in descending bid amounts. The website operator may be compensated by the advertisers based upon how many click-throughs each advertiser's website receives.

In accordance with one exemplary embodiment of the invention, advertisers can manually set bids on a per click-through basis. Thus, the system may order each advertiser based upon the highest to lowest bid per click-through. The website then may display the advertisers content (e.g., link, ad, etc.) in this order. In an exemplary embodiment, the advertisers may also have a monthly budget and the system may determine a daily balance based upon that monthly budget. In an exemplary embodiment, the system may allow for updated bidding and/or new bidders periodically and/or aperiodically, including, e.g., but not limited to, at certain predetermined time intervals. In addition, if an advertiser has exhausted its budget, then the advertisement placements for that advertiser may be no longer be displayed by the website. According to another exemplary embodiment, an advertiser may agree to automatically replenish its budget upon occurrence of certain conditions.

In accordance with another exemplary embodiment of the invention, referred to as an auto-bid mode, advertisers may provide, e.g., but not limited to, a monthly (or weekly) bid budget per keyword. The system may then determine a daily balance and may also assign a bid cost per click-through (CPC) based upon the monthly budget. According to an exemplary embodiment, the assigned CPC may be any amount that may be selected by the website operator. For example, the bid cost per click-through may be set to, e.g., but not limited to, 5¢ for the lowest monthly bidder and may increase by 0.5¢ increments for the next highest bidder. According to one exemplary embodiment, natively any other minimum bid cost per click-through, such as, e.g., but not limited to, 15%, etc. may be used and any other increment such as, e.g., but not limited to, 1¢, 2¢, etc. may be used. In response to a keyword selection in a search query by a user, the website may display each of the advertisers and their related information, including, but not limited to, e.g., website links, content., etc., in the order of the highest bidder to the lowest. In an exemplary embodiment of the invention, the system may continuously recalculates the advertiser budgets after certain predetermined time intervals (i.e., every 15 minutes, 30 minutes, once per day, etc.). The recalculation may involve, e.g., but not limited to, multiplying the number of click-throughs received by an advertiser by the bid per click-through and then subtracting this amount from the daily balance. Thus, an advertiser who receives a large number of click-throughs may have his or her daily balance depleted, thus losing a high placement on the website. In this manner, the advertiser placement may be continuously re-calculated and re-ordered to reflect the volume of traffic received by the various advertisers. In an exemplary embodiment, an advertiser's placements may be taken offline in the event that his or her daily balance and/or monthly budget has been depleted and/or may be replenished upon falling below a threshold, or other criterion. In an exemplary embodiment, the advertiser can also update the monthly budget which may result in changing his or her placement order with respect to other advertisers.

An exemplary embodiment of the invention may also allow for featured bids, whereby certain keywords may be selected as featured. If a keyword may be a featured bid, the key word may automatically be made the top bid at an increment of some amount of money, such as, for example, but not limited to, 0.5¢, 10¢, etc., higher than the normal top bid. If a keyword has two featured bids, according to an exemplary embodiment, then they may be 0.5¢ and 1¢ (or 20¢, etc.) higher than the other top bids.

The invention may also have a broad match functionality for, e.g., but not limited to, single-word keywords. For example, according to one exemplary embodiment, searching for a singular word may automatically search, e.g., but not limited to results of the plural form. Likewise, a plural keyword may automatically include results for the singular form, according to an exemplary embodiment.

Exemplary Embodiment of an Exemplary Power Bid Method

The invention provides a system and method for the dynamic auctioning of keyword search terms by internet search engines. In accordance with the invention, advertisers can place bids on certain keyword search terms. In response to the use of a certain keyword search term by a user, the website may provide e.g., but not limited to, advertiser information, including, e.g., but not limited to, advertiser website links, content, and/or advertisement placements for those advertisers who have bid on that keyword. The highest bidding advertiser may receive the highest placement on the host website, while the remaining advertisers may be displayed in descending bid amount order. The website operator may be compensated by the advertisers based upon how many click-throughs each advertiser's website receives.

In accordance with one exemplary embodiment of the invention, advertisers can manually set bids on a per click-through basis. Thus, the system may order each advertiser based upon the highest to lowest bid per click-through. The website then may display the advertisers in this order. In this exemplary embodiment, the advertisers may also have a monthly budget and the system may determine a daily balance based upon that monthly budget. In this exemplary embodiment, the system may allow for updated bidding and/or new bidders at certain predetermined time intervals, for example, etc. In addition, if advertisers have exhausted their budgets, then the advertisers' advertisement placements may no longer be displayed by the website, or means to replenish may be provided.

In one exemplary embodiment of the invention, the manual bidding functionality may include a Power Bid feature. The Power Bid may be an elevated bid that advertisers may have the option of selecting in order to increase their chances of having a winning or high bid. In one exemplary embodiment of the bid, the Power Bid may be calculated based upon an average of the three highest bids plus a certain predetermined percentage. For example, in one exemplary embodiment, the Powerbid may be calculated based on an average of, e.g., but not limited to, the three highest manual bids, raised by an amount such as, e.g., but not limited to, 15% of that average, expressed as follows:

If X = [(High Bid (HB) + Second High Bid (SHB) + Third High Bid
(THB))/3] and Predetermined Percentage = 15%, then
Power Bid = X + [Predetermined Percentage * X]

In other exemplary embodiments of the invention, the percentage uplift over the average of the group of high bids (such as, e.g., but not limited to, three highest bids) may vary. In one exemplary embodiment, the average may be determined based on, e.g., but not limited to, one, two, three, four, and/or more of the highest bids. In another exemplary embodiment, a predetermined percentage, or predetermined value, increase may be added to the highest bid, and may instead be referred to as a featured bid. In another exemplary embodiment of the invention, for example, the Power Bid may be set 20¢ higher than the average of the at least two highest bids. In accordance with exemplary embodiments of the invention, the Power Bid may be calculated at any predetermined time interval and may be based upon selecting a group of the highest bids over a certain time interval. For example, in one exemplary embodiment of the invention, the Power Bid may be calculated based on an average of a group of the highest bids made on a daily basis, and/or may be based upon taking an average of a group of bids, such as, e.g., but not limited to, the three highest bids, over the course of a historical period, such as, e.g., but not limited to, the last 30 days.

FIG. 1 shows a block diagram of the dynamic advertiser placement bidding system 100 in accordance with the invention. FIG. 1 shows a web server 102. Exemplary users 130 may be using user devices 104, 106 communicatively coupled to the web server, as may be advertiser users 132 using advertiser user devices 108, 110. FIG. 1 shows an application server 116, which may be executing a bid engine 118 in communication with the webserver 102. FIG. 1 may also show an exemplary ordering database 122 communicatively coupled to both the webserver 102 and the application server 116 which may be executing a bid engine 118. A records database 124 may be also communicatively coupled to the web server 102 and the application server 115, which may be executing bid engine 118. The advertisers 132 may be any type of advertisers 132 who would like their advertisements, which may include content, such as, e.g., but not limited to, website links, etc., which may be displayed by the web server 102. The advertisers 132 may be seeking to be listed prominently on the website in response to keyword searches by the users 130. The advertisers 132 may typically have an advertising budget from which they may provide, e.g., but not limited to, a daily, a weekly, a monthly, and/or a yearly, etc., bid, according to various exemplary embodiments of the invention. The users 130 may represent various consumers and/or or retailers of goods who may rely upon keyword searches to find various websites or other content that may have desired goods.

The web server 102 may provide an interface for users 130, as well as the advertisers 132. The web server 102 may receive information from each of the advertisers including, e.g., but not limited to, bids. The bids that may be received from the advertiser may be based upon individual keywords and/or groups of keywords. According to different exemplary embodiments of the invention, the bid may be for each click-through that an advertiser's website link receives and/or may be, e.g., but not limited to, a daily, a weekly, a monthly, and/or a yearly, etc., bid for a keyword. The web server 102 may also receive request for searches from users 130. These search requests may be in the form of keyword searches. The web server 105 may also record web traffic, including the number of click-throughs that users 130 make on a particular link. In response to keywords selected by users 130, the web server 102 may display the advertisement and advertiser website links and/or other content.

The bid engine 118 may include, in an exemplary embodiment, functionality for determining the order in which advertisers' listings should be displayed. In various exemplary embodiments of the invention, the ordering of the advertisers' listings may be based upon the advertiser who bids highest per keyword or the advertiser who has the largest monthly or weekly budget. In some exemplary embodiments of the invention, these bids may be updated and resubmitted at certain predetermined time intervals, such as, e.g., but not limited to, every day, every week, and/or on a monthly basis. The order database 130 may store the order to display the links of the advertisers, to be shown in response to a keyword selected by the users 130. The ordering of the advertisers may be determined by the bid engine 118 and may be from the highest bid per click-through (i.e., which may also be called cost per click (CPC)) to the lowest. The records database 124, according to an exemplary embodiment, may store information relating to the advertisers 132, such as, e.g., but not limited to, a record of data, which may include one or more fields, which may include, e.g., but not limited to, an advertiser's current, daily, weekly and/or monthly, etc., budget for keywords, a listing of keywords, and/or as well as a log of the number of clicks that each advertiser's website link may have received, etc. The information from the database 124 may be utilized by the bid engine 118, e.g., but not limited to, when updating the ordering of the advertisers.

In one exemplary embodiment of the invention, the advertisers 132 may select a manual bidding option. In the manual bidding option, advertiser's 132 can bid on keywords on a per click-through basis by accessing the web server 102. The advertisers 132 may be presented with a keyword management screen and can manually enter bids for one or more keywords. These bids may be received by the web server 102 and may be stored in the records database 124. The bid engine 118 may rank each of the bids for the same keyword from highest to lowest bid. This ranking may be stored in the order database 122. When a user 130 enters a keyword search, the website server 102 may provide a list of the advertisers 132 and listings which may include, e.g., but not limited to, the advertiser's webpage links in the rank order stored in the order database 122 (i.e., the advertisements and/or webpage links may be in the order of the highest bidder to the lowest). Thus, the users 130 may see the webpage link of the highest bidder first, followed by the other bidders in descending order. The web server 102 may also act as a traffic gauge and may record the number of click-throughs made by the users 130. The advertisers 132 may then be charged for each click-through recorded to the advertisers' respective links. The number of clicks per link may be stored in the database 135 in order to calculate how much each advertiser 132 owes the website operator. At certain predetermined time intervals, an advertiser's 132 daily (or other timeperiod) balance may be recalculated to reflect the deductions for payments to the website operator for click-throughs. In addition, if an advertiser's budget (e.g., but not limited to, daily, weekly, monthly and/or yearly, etc.) has been exhausted, his or her advertisements may no longer be displayed on the website, and/or if replenishment may be authorized, the account may need to be replenished prior to displaying further ads. The invention may also allow advertisers to update and/or revise their bids at certain predetermined time intervals. In this manner, the advertiser with the highest bid per click-through may command the highest placement for his or her website link or advertisement.

The manual bidding mode in accordance with one exemplary embodiment of the invention may also include an exemplary Power Bid feature. A Power Bid feature, according to an exemplary embodiment, may be an elevated bid that can be selected by any advertiser to increase that advertiser's chances of being the highest bidder. The Power Bid may be calculated in several ways in accordance with various exemplary embodiments of the invention. In one exemplary embodiment of the invention, the Power Bid may be the average of a group of highest bids per click-through, such as, e.g., but not limited to, the three highest bids by cost per click-through, increased by a percentage uplift, such as, e.g., but not limited to 15% (i.e., the product of 1.15 and the average of the three highest bids). In other exemplary embodiments of the invention, the percentage uplift multiple may be any number, such as, e.g., but not limited to, an increase of 10%, 20% or 30% over the average value, for example. Thus, the Power Bid may be calculated, in an exemplary embodiment, as:

If X = [(High Bid (HB) + Second High Bid (SHB) + Third
High Bid (THB))/3]
Power Bid = X + [.15 * X] = 1.15 * X.

Thus, in operation, an advertiser may select the Power Bid functionality when he or she selects access to the web server 102 and may be presented with an interface for providing a bid cost per click-through. Thus, an advertiser can request a Power Bid at any time and the amount of the Power Bid may be calculated as described above, in an exemplary embodiment. Once calculated, the Power Bid may be then ordered with the other received bids in the ordering database 130. In this manner, an advertiser may select the Power Bid functionality, may increase the advertiser's chances of being the highest bidder and, in turn, may increase their chances of having the highest advertisement placement position.

In accordance with the invention, the Power Bid my be calculated at any predetermined time interval and may be based upon three highest bids over a certain time interval. For example, in one exemplary embodiment of the invention, the Power Bid may be calculated daily and may be based upon the three highest bids over the course of the last 30 days. If there may be no second or third place bids, the system in accordance with an exemplary embodiment of the invention may look at a rolling 30 days trailing average for available positions and may average the group of high positions and may add a predetermined Power Bid increment (for example, but not limited to, 15%). In accordance with an exemplary embodiment of the invention, the Power Bid may not be lower than the advertiser's current bid. If the computed Power Bid may be lower than the current bid, then the current bid may be displayed. In addition, in accordance with one exemplary embodiment of the invention, the Power Bid cannot be less than a predetermined floor value, such as, e.g., but not limited to, 20¢, per click-through.

Exemplary Budget Logic

In an exemplary embodiment, advertisers who may be on the “Auto Bid” or “Monthly Budget” plans may use the slider to set the amount they want to spend in a month. This may be saved as advertiser_financing.monthly_budget amount, in an exemplary embodiment.

Although a monthly budget may be presented to the user in an exemplary embodiment, the budget logic may actually use a daily budget. The daily budget, may, daily, at midnight, in an exemplary embodiment, as follows be determined:
For each advertiser who registered this month after the 20th, in an exemplary embodiment: Add (monthly budget/days in month) to daily balance.
For all other advertisers, in an exemplary embodiment: Set daily balance to ((monthly budget−spent this month)/days left this month)

In an exemplary embodiment, the daily balance may be the amount that the advertiser has left to spend on the current day. In an exemplary embodiment, each click subtracts the CPC from the advertiser's daily balance. In an exemplary embodiment, when his daily balance drops to zero or lower, his ads go offline and no longer appear in search results. Because of partner latency issues, in an exemplary embodiment, the advertisers may be allowed to go −$25 in daily spend. In an exemplary embodiment, that negative amount may be part of the calculation made the next day for daily budget.

In an exemplary embodiment, the above description implements a daily budget, rather than a monthly budget. In an exemplary embodiment, a monthly budget may be calculated as follows: If the advertiser has spent greater than or equal to his monthly budget this month, then his ads go offline for the month. If the advertiser switches to another plan, and has funds, they may come back online. Also, if the budget may be increased, and there may be adequate funds, they may come back online.

In an exemplary embodiment, if an advertiser changes his monthly budget, then the daily budget may be recalculated at midnight for the next day. In an exemplary embodiment, any addition or subtraction may also be applied to the daily budget remaining. For example,
An advertiser with a $900 monthly budget changes to a $1500 monthly budget, in an exemplary embodiment. His daily budget may increase from $30 to $50, and his daily budget balance may be increased by $20, in an exemplary embodiment.
An advertiser with a $500 monthly budget changes to a $300 monthly budget, in an exemplary embodiment. His daily budget may decrease from $16.67 to $10, and his daily budget balance may be decreased by $6.67, in an exemplary embodiment. If the monthly budget amount may be less than the budget balance then the advertiser may be offline, in an exemplary embodiment.
   Automatic Billing Bonus

In an exemplary embodiment, any advertiser on a recurring billing plan (any plan except pay-as-you-go) may receive a 5% bonus, for each deposit after the first.

Automatic Bidding Logic

In an exemplary embodiment, by default, all advertisers may be in automatic bidding mode upon registration. In an exemplary embodiment, the bid amounts may be determined by an automated process which runs every 15 minutes. In an exemplary embodiment, if they change their budget amount within those first 15 minutes, it may be possible that they may be charged twice—once for the initial deposit and once for the new budget.

In an exemplary embodiment, the process loops through all keywords with at least one automatic bid. It selects all automatic bids for a particular keyword, and orders them by the daily budget balance for all advertisers on that keyword. The advertiser with lowest daily budget balance may be set to, in an exemplary embodiment, $0.15, with each higher balance raising the bid by $0.01. In an exemplary embodiment, automatic bids may not share CPC amounts with manual bids; they only occupy empty slots. The following example shows both automatic bids and manual bids ranked:

| | Autobid Daily Budget | |
|---|---|---|
| Manual Bids | Balance | Autobid CPC |
| | $50 | 0.19 |
| | $30 | 0.18 |
| 0.17 | | |
| | $20 | 0.16 |
| | $15 | 0.15 |
| 0.14 | | |
| 0.12 | | |
| 0.11, 0.11 | | |
| 0.10, 0.10, 0.10, 0.10 | | |

In an exemplary embodiment, the maximum Autobid amount may be $1.00. In an exemplary embodiment, if there may be more automatic bids than available CPC slots, then automatic bids may share CPC with manual bids, starting with the highest manual bid amounts. For example, if there were enough Autobids to reach $1.02, then two manual amounts must be shared and made available to the Autobid:

| Manual Bids | Autobid Daily Budget Balance | Autobid CPC |
|---|---|---|
| 1.00 | $100 | 1.00 (share with manual) |
| | $90 | 0.99 |
| 0.98 | $80 | 0.98 (share with manual) |
| | $70 | 0.97 |
| 0.96 | | |
| | $60 | 0.95 |
| . . . | . . . | . . . |

In an exemplary embodiment, if a keyword has more than 85 Autobids, then the highest 85 may be priced $1.00 through $0.16, and all remaining may be priced $0.15.

In an exemplary embodiment, a broad match rules (see below) may be implemented, which may have an effect on auto bidding. In an exemplary embodiment, when lining up bids for a keyword, Autobid may take into account the broad matched keywords (if any), and ensure that two advertisers may be not sharing the same bid amount for a broad match term. In an exemplary embodiment, this may be best shown by example:

| | | Daily | | | |
|---|---|---|---|---|---|
| | | Budget | | | |
| Advertiser | Bid Type | Balance | “Clothing” | “Clothes” | “Apparel” |
| Advertiser #1 | Autobid | $30 | | Yes; 0.19 | Yes; 0.19 |
| Advertiser #2 | Autobid | $20 | Yes; 1.18 | Yes; 1.18 | |
| Advertiser #3 | Autobid | $15 | Yes; 0.17 | | Yes; 0.17 |
| Advertiser #4 | Manual | | | Yes; 0.16 | |
| Advertiser #5 | Autobid | $10 | Yes; 0.15 | | |

In an exemplary embodiment, for an advertiser on Autobid, there may be no difference between selecting only one term, several terms, or all terms in a broad match group; the end result may be the same (n an exemplary embodiment, with the exception of featured status).

Manual Bidding Logic

In an exemplary embodiment, an advertiser may choose, via e.g. but not limited to, My Account tools, any of the 3 manual bidding plans offered—Monthly Budget, Constant Traffic, or Pay as you Go. In an exemplary embodiment, they select their bid amounts on a keyword by keyword basis.

In an exemplary embodiment, the manual bids may be ranked along with auto bids to determine their results positioning. In an exemplary embodiment, if the advertiser switches from an automatic bidding mode to a manual bidding mode, one of two things may happen:
If he never was in a manual bidding mode then all bids may be set to the current power bid amount for each keyword, in an exemplary embodiment.
If he was previously in a manual bidding mode then all bids may be set to whatever they were the last time in manual bid, or $0.15 if the previous manual bid was less, in an exemplary embodiment.
   Featured Bids

In an exemplary embodiment, a certain number of bids for a specific keyword may be selected as featured; these may be available on a first come, first serve basis. In an exemplary embodiment, a keyword may have up to 3 featured ads.

In an exemplary embodiment, if a keyword has a featured bid, it may automatically be the top bid, at $0.01 more then the normal top bid. In an exemplary embodiment, if a keyword has 2 featured bids, they may automatically be #1 at $0.02 more and #2 at $0.01 more. In an exemplary embodiment, which of the keywords may be on top may be chosen at random. For example:

| Bid | CPC |
|---|---|
| (featured) | $0.32 |
| (featured) | $0.31 |
| $0.30 | $0.30 |
| $0.25 | $0.25 |
| $0.20 | $0.20 |

In an exemplary embodiment, a featured bid must cost at least the official minimum bid (currently 0.15) regardless of other grandfathered 0.10 bids. For example:

| Bid | CPC |
|---|---|
| (featured) | $0.16 |
| (featured) | $0.15 |
| $0.10 | $0.10 |

Broad Match

In an exemplary embodiment, there may be 3 types of broad match and the rules may be only applied on our network of direct sites (GW, W411, Wholesale.com and CoBrands).

In an exemplary embodiment, all ads keep the same bid amount, regardless of whether they matched the main search, or the broad match keyword. In an exemplary embodiment, the broad match logic essentially may place an implied bid for an advertiser for the broad match terms, at the same bid amount, if he does not already have the broad match term.

In an exemplary embodiment, broad match may not transfer featured status; if an advertiser wishes to be featured on a keyword, he may feature that exact keyword. In an exemplary embodiment, if a featured keyword may be broad matched, then the featured status may be cleared, and the bid may be set as the normal CPC for that keyword (high bid +0.01).

In an exemplary embodiment, while this functionality may be mainly a part of the search module, it may also affect the Autobid logic. In an exemplary embodiment, when lining up bids for a keyword, Autobid must take into account the broad matched keywords (if any), and ensure that two advertisers may be not sharing the same bid amount for a broad match term. This may be best shown by example:

| | | Daily | | | |
|---|---|---|---|---|---|
| | | Budget | | | |
| Advertiser | Bid Type | Balance | “Clothing” | “Clothes” | “Apparel” |
| Advertiser #1 | Autobid | $30 | | Yes; 0.19 | Yes; 0.19 |
| Advertiser #2 | Autobid | $20 | Yes; 0.18 | Yes; 0.18 | |
| Advertiser #3 | Autobid | $15 | Yes; 0.17 | | Yes; 0.17 |
| Advertiser #4 | Manual | | | Yes; 0.16 | |
| Advertiser #5 | Autobid | $10 | Yes; 0.15 | | |

In an exemplary embodiment, for an advertiser on Autobid, there may be no difference between selecting only one term, several terms, or all terms in a broad match group; the end result may be the same (in an exemplary embodiment, with the exception of featured status, as described above)

Singular/Plural

In an exemplary embodiment, the singular/plural matches may be pre-defined in the system, an example of which may be shown below. In an exemplary embodiment, searching for a singular may automatically return results for the plural and vice versa. In an exemplary embodiment, all advertiser keywords may have a singular/plural broad match applied to them, according to an exemplary embodiment.

| | |
|---|---|
| accessory | accessories |
| bead | beads |
| dropshipper | dropshippers |
| dvd | dvds |

Category

In an exemplary embodiment, categories may be pre-defined groups of 2 or more search terms that may be pre-defined in the system, an example of which may be shown below. In an exemplary embodiment, searching for a term in the group may automatically include results for the other terms. For example, searching for “attire” could return results for “clothing” and “Clothes.”

| | | |
|---|---|---|
| closeouts | closeout merchandise | closeout |
| clothing | Clothes | attire |
| distributors | distributor | distribution |
| drop shippers | drop shipper | drop shipping |
| handbags | handbag | Purses |

One Way Matching

In an exemplary embodiment, one way matching may be customer driven where a specific search term may broad match to a more general search term. For example, searching for “Gold Jewelry” may also return results for “Jewelry”.

In an exemplary embodiment, if the search term has multiple words, the most popular (e.g. highest revenue) search term that can be built using those words may be returned. For example:

Searching for “mens apparel”.
Most popular term with those words may be “apparel”.
Broad match to “apparel”, “clothing”, “clothes” etc.
Searching for “antique gold jewelry”.
Most popular term with those words may be “jewelry”.
Broad match to “jewelry”.
Searching for “xbox 360”.
Term may already be defined in the synonym CSV, so no changes.
Broad match to “xbox”, “x box”, “x box 360” etc.
Searching for “drop ship gifts”.
Most popular term with those words may be “gifts”.
Broad match to “gifts”, “gift”.
(If “drop ship” had been more popular, the broad matched could have been made to “drop ship”, “dropshipper”, “dropshipping”, etc)

In an exemplary embodiment, a keyword may not display as featured unless the advertiser has that exact keyword selected as featured. In an exemplary embodiment, if a featured keyword may be selected through broad match, it may lose its featured status for that search, but keep the same (or approximately the same) CPC that it would normally have (highest CPC+0.01), so it would still rank highly in the search results.

Power Bid

In an exemplary embodiment, power bid may be calculated every day at 7 am by taking the average CPC of the top 3 positions for each keyword (based on # of clicks for the previous day)×15%. In an exemplary embodiment, if the calculation may less than $0.25 then display $0.25. For example, the top 3 CPC's for Jewelry may be $0.38, $0.36 and $0.34=$0.36×1.15=$0.41. In an exemplary embodiment, if the calculation total was less than $0.25, the power bid would be set to $0.25.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it may be understood to those having ordinary skill in the art that changes in the above description or illustrations may be made with respect to formal detail without departing from the spirit and scope of the invention.

1. A method comprising:
receiving a search query;
parsing said search query into at least one keyword;
retrieving a plurality of search listings, including at least one auto-bid search listing, associated with said keyword, wherein each of said plurality of search listings is associated with a bid amount;
sorting said at least one auto-bid search listings in an order of a first budget balance associated with said at least one auto-bid search listings, wherein said first budget balance is calculated based on a first budget associated with said auto-bid search listing;
determining a bid amount for each of said at least one auto bid search listings corresponding to said order of said first budget balance, said bid amount incremented from a minimum auto-bid amount to a maximum auto-bid amount; and
sorting at least a portion of said plurality of search listings based on said bid amount.

2. The method of claim 1, wherein said plurality of search listings comprise at least one manual bid search listing.

3. The method of claim 2, wherein said determining a bid amount comprises:
setting the bid amount of the auto-bid search listing associated with the lowest first budget balance to the lowest bid amount that is greater than or equal to said minimum auto-bid amount and is not equal to the bid amount of any of the plurality of manual bit search listings; and
for each of the remaining auto-bid search listings in said at least one auto-bid search listings,
setting the bid amount of said auto-bid search listing to the bid amount of the previously-set auto-bit listing incremented by a bid increment amount;
determining whether the bid amount of said auto-bid search listing is equal to the bid amount of any of the at least one manual bid search listing; and
if so, continuously incrementing the bid amount of said auto-bid search listing by said bid increment amount until reaching an amount that is not equal to the bid amount of any of the at least one manual bid search listings.

4. The method of claim 3, wherein the bid amount associated with any auto-bid search listings exceed said maximum auto-bid amount, said determining a bid amount further comprises comprising:
setting the bid amount of the auto-bid search listing associated with the highest first budget balance to said maximum auto-bid amount;
for each of the remaining auto-bid search listings:
if the bid amount of said auto-bid search listing is equal to or greater than the bid amount of a previously-set auto-bid search listing, setting the bid amount of said auto-bid search listing to the bid amount of the previously-set auto-bid search listing decremented by a bid decrement amount; and
if said bid amount of said auto-bid search listing reaches said minimum auto-bid amount, then
setting the bid amount of each of the remaining auto-bid search listings to said minimum auto-bid amount.

5. (canceled)

6. (canceled)

7. The method of claim 1, wherein said first budget is allocated for a first time period and said first budget balance is calculated as the difference between said first budget and the amount of said first budget so far expended in said first time period.

8. (canceled)

9. The method of claim 7, further comprising:
determining whether said first budget balance is less than a first budget minimum; and
if so, setting all search listings associated with said first budget offline.

10. The method of claim 7, further comprising auto-replenishing said first budget from a financial account associated with said first budget if said first budget balance is less than a first budget minimum and an auto-replenishment option is available for said budget.

11. (canceled)

12. (canceled)

13. The method of claim 7, further comprising:
setting search listings associated with said first budget offline if said first budget balance is less than a first budget minimum; and
setting search listings associated with said first budget online if said first budget balance is greater than or equal to said first budget minimum.

14. The method of claim 7, wherein said first budget is calculated based on a second budget, said second budget being allocated for a second time period, further comprising:
calculating a second budget balance as the difference between said second budget and the amount of said second budget so far expended in said second time period, performed at least once within every first time period; and
calculating said first budget as a second budget balance divided by the number of first time periods remaining in said second time period.

15. (canceled)

16. (canceled)

17. The method of claim 1, wherein each of said plurality of search listings is associated with a user account, further comprising:
auto-replenishing said user account from a financial account associated with said user account if said user account is less than an account minimum and an auto-replenishment option is available for said user account; and
setting all search listings associated with said user account offline if said auto-replenishment option is not available and said user account is less than said account minimum.

18. (canceled)

19. (canceled)

20. (canceled)

21. (canceled)

22. (canceled)

23. (canceled)

24. The method of claim 14, wherein said first time period is a 24-hour day, said second time period is a month, said first time budget is a daily budget, and said second budget is a monthly budget.

25. (canceled)

26. (canceled)

27. (canceled)

28. (canceled)

29. (canceled)

30. (canceled)

31. (canceled)

32. (canceled)

33. The method of claim 1, wherein said plurality of search listings comprises at least one featured bid search listing, said method further comprising:
calculating a bid amount for one of at least one featured bid search listings by incrementing the highest bid amount associated with said plurality of search listings by a predetermined feature bid increment amount;
for all remaining featured bid search listings in said at least one featured bid search listings:
selecting a featured bid search listing from said at least one featured bid search listings; and
calculating a bid amount for said featured bid search listing by incrementing the bid amount of a previously-set featured bid search listing by a predetermined feature bid increment amount.

34. The method of claim 1, where said first budget is an advertising budget associated with an advertiser, further comprising:
receiving said advertising budget from said advertiser;
receiving a plurality of said keywords from said advertiser,
receiving a bidding option from said advertiser, said bidding option being associated with either each of said plurality of said keywords individually or with said plurality of keywords collectively; and
receiving a selection of a payment plan from the advertiser, said payment plan comprises at least one of a term budget plan, a constant traffic plan, and/or a pay-per-click plan, wherein said term budget plan comprises at least one of a daily, weekly and/or monthly budget plan.

35. (canceled)

36. (canceled)

37. (canceled)

38. (canceled)

39. (canceled)

40. (canceled)

41. (canceled)

42. (canceled)

43. The method of claim 1, further comprising:
receiving a click-through for at least one of said plurality of search listings; and
deducting the bid amount of said search listing associated with said click-through from the first budget balance of said search listing.

44. The method of claim 1, wherein said bid amount is associated with at least one of a cost-per-click, a cost-per-listing, a cost-per-call, and/or cost-per-sale.

45. (canceled)

46. A method comprising:
receiving a search query;
parsing said search query into at least one keyword;
retrieving a plurality of auto-bid search listings associated with said keyword, wherein each of said plurality of auto-bid search listings is associated with a first budget;
calculating a first budget balance associated with each of said auto-bid search listings, wherein said first budget balance is calculated based on said first budget;
sorting said plurality of said auto-bid search listings in the order of said first budget balances; and
determining a bid amount for each of said auto-bid search listings based on the sorted order from a minimum auto-bid amount to a maximum auto-bid amount.

47. (canceled)

48. (canceled)

49. The method of claim 46, wherein said determining a bid amount comprises:
setting the bid amount of the auto-bid search listing associated with the lowest first budget balance to said minimum auto-bid amount;
setting the bid amount of each of the next auto-bid search listings to the bid amount of its previous auto-bid search listing incremented by a bid increment amount as traversing through said plurality of auto-bid search listings in the sorted order.

50. The method of claim 49, wherein said determining a bid amount further comprises:
determining whether the bid amount of the auto-bid search listing associated with the highest first budget balance exceeds said maximum auto-bid amount; and
if so,
setting the bid amount of the auto-bid search listing associated with the highest first budget balance to said maximum auto-bid amount; and
setting the bid amount of each of the next auto-bid search listings to the bid amount of its previous auto-bid search listing decremented by a bid decrement amount as traversing through said plurality of auto-bid search listings in the reverse of the sorted order until said bid amount of said auto-bid search listing reaches said minimum auto-bid amount, then setting the bid amount of each of the remaining auto-bid search listings to said minimum auto-bid amount.

51. (canceled)

52. The method of claim 50, wherein said determining a bid amount further comprises:
determining whether the number of auto-bid search listings in said plurality of auto-bid search listings is greater than the difference between a maximum auto-bid amount and a minimum auto-bid amount divided by a bid increment amount;
if so,
setting the bid amount of the auto-bid search listing associated with the lowest first budget balance to said minimum auto-bid amount;
setting the CPC of each of the next auto-bid search listings to the bid amount of its previous auto-bid search listing incremented by a bid increment amount as traversing through said plurality of auto-bid search listings in the sorted order;
otherwise,
setting the bid amount of the auto-bid search listing associated with the highest first budget balance to said maximum auto-bid amount;
setting the bid amount of each of the next auto-bid search listings to the bid amount of its previous auto-bid search listing decremented by a bid decrement amount as traversing through said plurality of auto-bid search listings in the reverse of the sorted order until said bid amount of said auto-bid search listing reaches said minimum auto-bid amount, then setting the bid amount of each of the remaining auto-bid search listings to said minimum auto-bid amount.

53. (canceled)

54. A method of calculating a power bid comprising:
taking an average of a plurality of high bids; and
setting the power bid to said average raised by at least one of a predetermined percentage and/or a predetermined amount.

55. The method of claim 54, wherein said high bids includes one, two, three and/or more bids and said predetermined percentage is at least one of five percent, ten percent, fifteen percent, and/or more.

56. (canceled)

57. The method of claim 54, further comprising:
determining whether the power bid is below a minimum power bid amount; and
if so, setting the power bid to said minimum power bid amount.

58. The method of claim 54, wherein said average of said high bids equals X, wherein said X=((a Highest Bid (HB)+a Second Highest Bid (SHB)+a Third Highest Bid (THB))/3, and wherein said power bid=[X+[0.15*X]].

59. (canceled)

60. The method of claim 1, wherein said determining a bid amount comprises:
setting the bid amount of the auto-bid search listing associated with the lowest first budget balance to said minimum auto-bid amount;
incrementing the bid amount of the subsequent auto-bid search listings, in the order of the first budget balance, by a bid increment amount;
determining if the bid amount associated with any auto-bid search listings exceeds said maximum auto-bid amount; and, if so:
setting the bid amount of the auto-bid search listing associated with the highest first budget balance to said maximum auto-bid amount; and
decrementing the bid amount of subsequent auto-bid search listings, in the decreasing order of the first budget balance, by a bid decrement amount until the bid amount reaches said minimum auto-bid amount, then setting the auto-bid amount of the remaining auto-bid search listings to said minimum auto-bid amount

61. (canceled)

62. A method of claim 7, wherein said amount of first budget so far expended corresponds to an amount expended from a user account to pay for at least one of listing displays, click-throughs, call-throughs, and/or sale-throughs for at least one search listing associated with said account, wherein said calculating said first budget balance takes place at set predetermined time intervals, and said sorting at least a portion of said plurality of search listings takes place at set predetermined time intervals.

63. (canceled)

64. (canceled)

65. (canceled)
